(19) United States
(12) Patent Application Publication
(10) Pub. No.: US 2025/0055648 A1
(43) Pub. Date: Feb. 13, 2025

(54) INFORMATION FEEDBACK METHOD AND APPARATUSES THEREOF

(71) Applicant: FUJITSU LIMITED, Kawasaki-shi Kanagawa (JP)

(72) Inventors: Qinyan JIANG, Beijing (CN); Jian ZHANG, Beijing (CN); Lei ZHANG, Beijing (CN)

(73) Assignee: FUJITSU LIMITED, Kawasaki-shi Kanagawa (JP)

(21) Appl. No.: 18/796,415

(22) Filed: Aug. 7, 2024

Related U.S. Application Data
(63) Continuation of application No. PCT/CN2022/076109, filed on Feb. 11, 2022.

(51) Int. Cl. H04L 5/00; H04L 1/1812; H04L 1/1829; H04W 72/23

(52) U.S. Cl. CPC H04L 5/0055; H04L 1/1854; H04W 72/23; H04L 1/1812

(57) ABSTRACT

An information feedback apparatus, applicable to a terminal equipment, includes: processor circuitry configured to: determine a candidate PDSCH reception occasion set, and determine bits of HARQ-ACK information in an HARQ-ACK codebook according to the number of scheduled PDSCHs and/or according to the number of scheduled valid PDSCHs; and a transmitter configured to transmit the codebook, the codebook including HARQ-ACK information to which the candidate PDSCH reception occasion set corresponds.

### CROSS-REFERENCE TO RELATED APPLICATION

This application is a continuation application of International Application PCT/CN2022/076109 filed on Feb. 11, 2022, and designated the U.S., the entire contents of which are incorporated herein by reference.

### FIELD

This disclosure relates to the field of communication technologies.

### BACKGROUND

A physical downlink shared channel (PDSCH) is one of physical downlink channels used in a wireless communication system to carry downlink data. The PDSCH may be scheduled by downlink control information (DCI). The DCI used for scheduling the PDSCH at least includes information indicating resources of the PDSCH. In a current new radio (NR) system, various DCI formats for scheduling the PDSCH have been defined, such as DCI format 1_0 (PDSCH), DCI format 1_1 (PDSCH), and DCI format 1_2 (PDSCH), and information included in DCI and/or sizes of different DCI formats are different, so as to meet different scheduling demands.

The PDSCH may also be semi-statically configured or semi-persistently scheduled. In the new radio NR, the semi-statically configured or semi-persistently scheduled PDSCH is referred to, for example, a semi-persistent scheduling (SPS) PDSCH (SPS PDSCH). In some cases, a terminal equipment receives the SPS PDSCH accordingly when a network device activates SPS configuration via the DCI after providing the SPS configuration via radio resource control (RRC) signaling. Furthermore, in addition to scheduling the PDSCH and activating SPS, the DCI may be used to deactivate SPS, make a cell dormant, etc. Semi-statically configuring is configuring by a higher-layer parameter (tdd-UL-DL-ConfigurationCommon) at a cell level, so as to configure transmission direction types of symbols in a period, and/or configuring by a higher-layer parameter (tdd-UL-DL-ConfigurationDedicated) at a user-dedicated level, so as to further configure transmission direction types of symbols in resources with a transmission direction type “X” after being configured at a previous level.

In order for the network device to determine whether the terminal equipment has successfully received downlink data and/or control information, in general, the terminal equipment needs to feed back hybrid automatic repeat request (HARQ) feedback information (such as ACK/NACK). According to scheduling of the network device, the HARQ feedback information may be carried by a physical uplink control channel (PUCCH) or a physical uplink shared channel (PUSCH). Generally, a PUCCH or PUSCH is able to carry one HARQ feedback codebook, the codebook including one or more HARQ feedback information bits.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

Currently, an NR system supports scheduling more than one PDSCH by a single DCI (PDCCH), and how to support such a scheduling mode and corresponding HARQ-ACK feedback enhancement are still under discussion. However, in a case where an HARQ feedback codebook enables time domain bundling via RRC signaling, it is currently not specified whether/how to support transmitting/receiving more than one PDSCH per slot, or whether/how to support indicating/scheduling more than one PDSCH with only one valid PDSCH by a physical downlink control channel (PDCCH), or whether/how to support associating more than one PDSCH by a candidate PDSCH reception occasion and scheduling the more than one PDSCH by different DCIs or in different modes, and an HARQ feedback method in the above situations is not specified. That is, a network device and a terminal equipment may have different understandings of whether the above PDSCH scheduling is allowed. Therefore, if the above situations occur when the network device schedules the PDSCHs, the terminal equipment may possibly be unable to correctly receive the scheduled PDSCHs and/or feed back corresponding HARQ-ACK information, resulting in unnecessary retransmission and resource waste.

In order to solve at least one of the above problems, embodiments of this disclosure provide an information feedback method and a scheduling configuration method and apparatuses thereof.

According to one aspect of the embodiments of this disclosure, there is provided an information feedback apparatus, applicable to a terminal equipment, wherein the apparatus includes:
a first determining unit configured to determine a candidate PDSCH reception occasion set according to whether time domain bundling is configured and/or whether multi-PDSCH scheduling is configured and/or a subcarrier spacing of a downlink BWP and/or whether it is capable of receiving more than one PDSCH per slot; and
a first processing unit configured to generate and transmit an HARQ-ACK codebook, the codebook including HARQ-ACK information to which the candidate PDSCH reception occasion set corresponds.

According to another aspect of the embodiments of this disclosure, there is provided an information feedback apparatus, applicable to a terminal equipment, wherein the apparatus includes:
a second determining unit configured to determine a candidate PDSCH reception occasion set; and
a fourth processing unit configured to determine bits of HARQ-ACK information in an HARQ-ACK codebook according to the number of scheduled PDSCHs and/or according to the number of scheduled valid PDSCHs, and transmit the codebook, the codebook including HARQ-ACK information to which the candidate PDSCH reception occasion set corresponds.

An advantage of the embodiments of this disclosure exists in that in a case where time domain bundling is configured, it is specified whether/how to support transmitting/receiving more than one PDSCH per slot, or whether/how to support indicating/scheduling more than one PDSCH with only one valid PDSCH by a physical downlink control channel (PDCCH), or whether/how to support associating more than one PDSCH by a candidate PDSCH reception occasion and scheduling the more than one PDSCH by different DCIs or in different modes, and an HARQ feedback method in the above situations is specified. Hence, the network device and the terminal equipment may have identical understandings of whether the above PDSCH scheduling is allowed, and if the above situations occur when the network device schedules the PDSCHs, the terminal equipment may be able to correctly receive the scheduled PDSCHs and/or feed back corresponding HARQ-ACK information, thereby avoiding unnecessary retransmission and resource waste.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/including/includes” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is schematic diagram of a communication system of embodiments of this disclosure;

FIG. 2 is a schematic diagram of an information feedback method of embodiments of this disclosure;

FIG. 3 is a schematic diagram of a scheduling configuration method of embodiments of this disclosure;

FIG. 4 is another schematic diagram of a scheduling configuration method of embodiments of this disclosure;

FIG. 5A is a schematic diagram of a candidate PDSCH reception occasion set of embodiments of this disclosure;

FIG. 5B is a schematic diagram of a candidate PDSCH reception occasion set of embodiments of this disclosure;

FIG. 5C is a schematic diagram of a candidate PDSCH reception occasion set of embodiments of this disclosure;

FIG. 5D is a schematic diagram of a candidate PDSCH reception occasion set of embodiments of this disclosure;

FIG. 5E is a schematic diagram of a candidate PDSCH reception occasion set of embodiments of this disclosure;

FIG. 6 is a schematic diagram of a scheduling configuration method of embodiments of this disclosure;

FIG. 7 is a schematic diagram of a scheduling configuration method of embodiments of this disclosure;

FIG. 8 is a schematic diagram of an information feedback method of embodiments of this disclosure;

FIG. 9 is a schematic diagram of an information configuration method of embodiments of this disclosure;

FIG. 10 is another schematic diagram of an information configuration method of embodiments of this disclosure;

FIG. 11 is a schematic diagram of an information feedback method of embodiments of this disclosure;

FIG. 12 is a schematic diagram of an information feedback apparatus of embodiments of this disclosure;

FIG. 13 is a schematic diagram of a scheduling configuration apparatus of embodiments of this disclosure;

FIG. 14 is a schematic diagram of a scheduling configuration apparatus of embodiments of this disclosure;

FIG. 15 is a schematic diagram of an information feedback apparatus of embodiments of this disclosure;

FIG. 16 is a schematic diagram of an information configuration apparatus of embodiments of this disclosure;

FIG. 17 is a schematic diagram of an information feedback apparatus of embodiments of this disclosure;

FIG. 18 is a schematic diagram of a scheduling configuration apparatus of embodiments of this disclosure;

FIG. 19 is a schematic diagram of a scheduling configuration apparatus of embodiments of this disclosure;

FIG. 20 is a schematic diagram of an information configuration apparatus of embodiments of this disclosure;

FIG. 21 is a schematic diagram of a network device of embodiments of this disclosure; and

FIG. 22 is a schematic diagram of a terminal equipment of embodiments of this disclosure.

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” or “terminal equipment (TE) or terminal device” refers to, for example, an equipment accessing to a communication network and receiving network services via a network device. The user equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the terminal equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipments described above. “A device” in this text may refer to a network device, and may also refer to a terminal equipment, except otherwise specified.

In the embodiments of this disclosure, a time unit may be a subframe, or a slot, or a set containing at least one time domain symbol. The set of at least one time domain symbol may also be referred to as a mini-slot or a non-slot. For example, in the embodiments of this disclosure, a subframe and a slot are interchangeable, and “a slots” may also be replaced with “a subframe”, and this disclosure is not limited thereto. For the sake of convenience, following description shall be given by taking “a slot” as an example; however, it may also be replaced with other time units. In addition, the terms “a time domain resource” and “a resource” are interchangeable.

In the following description, without causing confusion, the terms “uplink control signal” and “uplink control information (UCI)” or “physical uplink control channel (PUCCH)” are interchangeable, and terms “uplink data signal” and “uplink data information” or “physical uplink shared channel (PUSCH)” are interchangeable.

The terms “downlink control signal” and “downlink control information (DCI)” or “physical downlink control channel (PDCCH)” are interchangeable, and the terms “downlink data signal” and “downlink data information” or “physical downlink shared channel (PDSCH)” are interchangeable.

In addition, transmitting or receiving a PUSCH may be understood as transmitting or receiving uplink data carried by the PUSCH, transmitting or receiving a PUCCH may be understood as transmitting or receiving uplink information (e.g. UCI) carried by the PUSCH, transmitting or receiving a PRACH may be understood as transmitting or receiving a preamble carried by the PRACH, transmitting or receiving a PDSCH may be understood as transmitting or receiving downlink data carried by the PDSCH, and transmitting or receiving a PDCCH may be understood as transmitting or receiving downlink information (e.g. DCI) carried by the PDCCH.

In the embodiments of this disclosure, higher-layer signaling may be, for example, radio resource control (RRC) signaling; for example, it is referred to an RRC message, which includes a master information block (MIB), system information, and a dedicated RRC message; or, it is referred to an as an RRC information element (RRC IE). Higher-layer signaling may also be, for example, medium access control (MAC) signaling, or an MAC control element (MAC CE); however, this disclosure is not limited thereto.

Scenarios in the embodiments of this disclosure shall be described below by way of examples; however, this disclosure is not limited thereto.

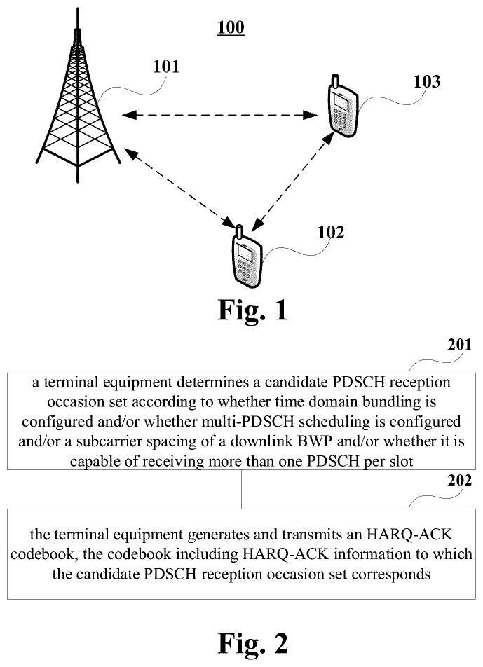

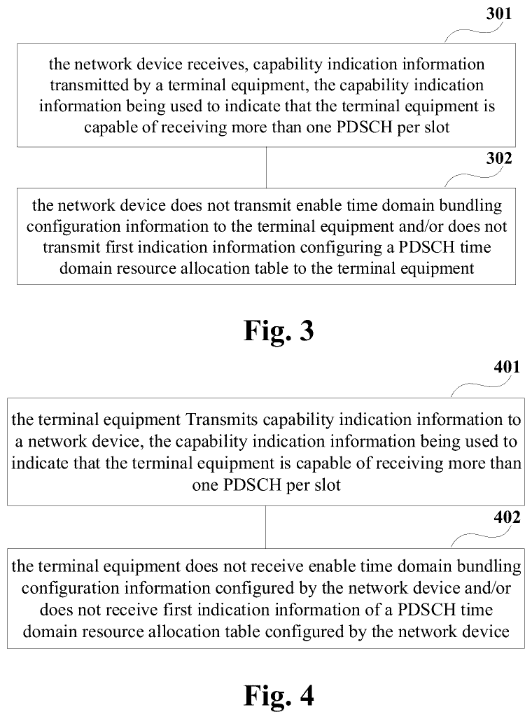

FIG. 1 is a schematic diagram of a communication system of embodiments of this disclosure, in which a case where terminal equipment and a network device are taken as examples is schematically shown. As shown in FIG. 1, a communication system 100 may include a network device 101 and terminal equipment 102, 103. For the sake of simplicity, an example having only two terminal equipment and one network device is schematically given in FIG. 3; however, the embodiments of this disclosure are not limited thereto.

In the embodiments of this disclosure, existing services or services that may be implemented in the future may be performed between the network device 101 and the terminal equipment 102, 103. For example, such services may include but not limited to an enhanced mobile broadband (eMBB), massive machine type communication (MTC), ultra-reliable and low-latency communication (URLLC), and related communications of reduced capability terminal equipments, etc.

It should be noted that FIG. 1 shows that two terminal equipment 102, 103 are both within coverage of the network device 101. However, this disclosure is not limited thereto, and the two terminal equipment 102, 103 may not be within the coverage of the network device 101, or one terminal equipment 102 is within the coverage of the network device 101 and the other terminal equipment 103 is outside the coverage of the network device 101.

In the embodiments of this disclosure, transport blocks carried by different PDSCHs are identical or different. Therefore, “more than one PDSCH (multiple PDSCHs)” or “at least two PDSCHs” below refers to different PDSCHs carrying different transport blocks. More specifically, the transport blocks carried by different PDSCHs may correspond to identical or different HARQ processes, wherein different HARQ processes are identified by different HARQ process identifiers.

In some embodiments, a PDSCH time domain resource allocation (TDRA) table (or a TDRA table in brief) includes at least one row, which is hereinafter referred to as a PDSCH TDRA configuration (or a TDRA configuration in brief) for ease of description, that is, the PDSCH TDRA table includes at least one PDSCH TDRA configuration. A PDSCH TDRA configuration includes at least one PDSCH time domain resource configuration (or referred to as a time domain resource configuration in brief), which at least includes a symbol position (starting symbol+length) configuration in a slot; in addition, a PDSCH TDRA configuration may further include at least one slot offset K0 configuration, K0 denoting a slot offset between a PDSCH and a PDCCH, and the K0 configuration being included or not included in the PDSCH time domain resource configuration; the PDSCH TDRA configuration may further include other information, which is included or not included in a PDSCH time domain resource configuration, and the embodiments of this disclosure are not limited thereto. Regarding the symbol position configuration in the slot, it includes, for example, a start and length indicator SLIV, the SLIV corresponding to a valid combination of a starting symbol(S) and a length (L), or, for example, corresponding to a starting symbol configuration and a length configuration, the starting symbol configuration and a length configuration being a valid combination.

In existing methods, in determining an HARQ feedback codebook (such as a Type-1 HARQ-ACK codebook, or a semi-static HARQ-ACK codebook), a candidate PDSCH reception occasion set needs to be determined first, and then bits of HARQ feedback (hereinafter referred to as HARQ-ACK) information to which the candidate PDSCH reception occasions correspond are determined. In determining the candidate PDSCH reception occasion set, if at least one row in a TDRA table contains an SLIV that does not collide with a semi-statically configured uplink symbol (one row includes one SLIV), the candidate PDSCH reception occasion is reserved.

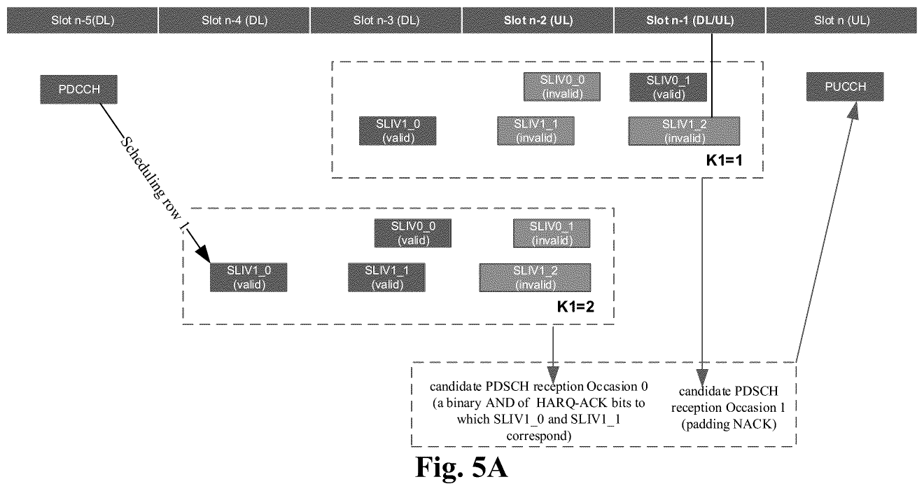

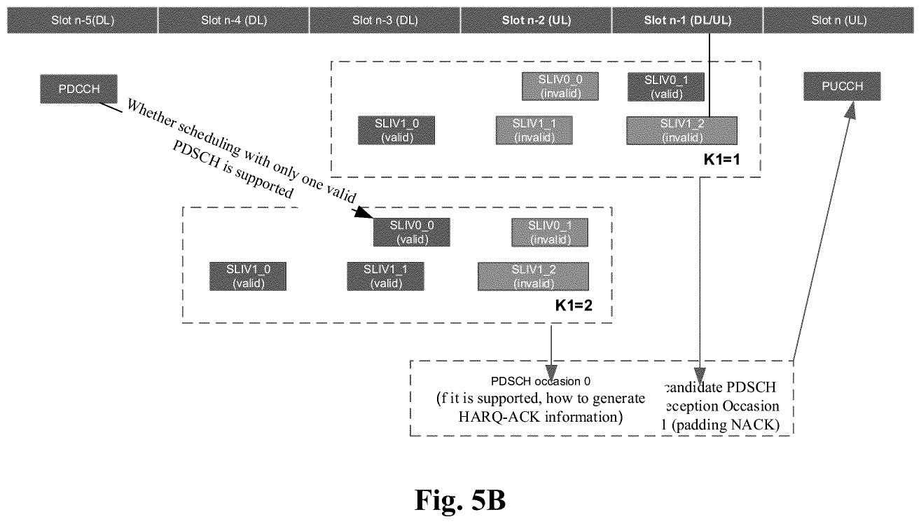

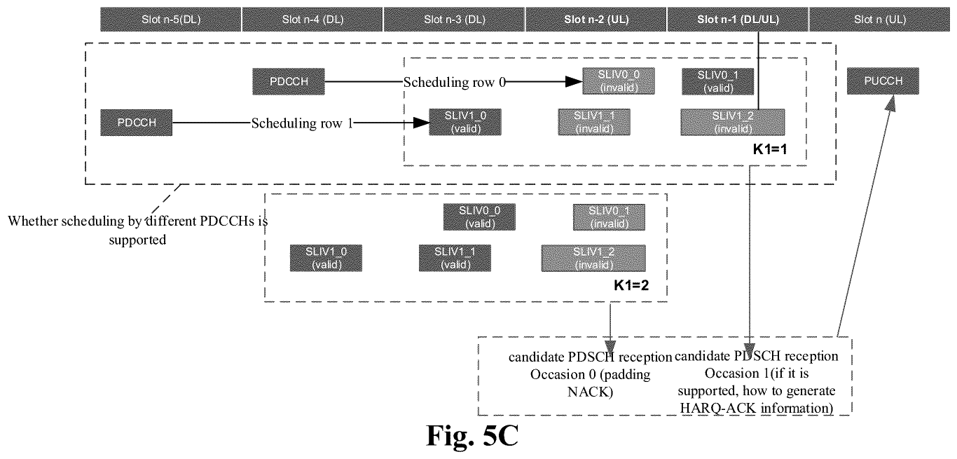

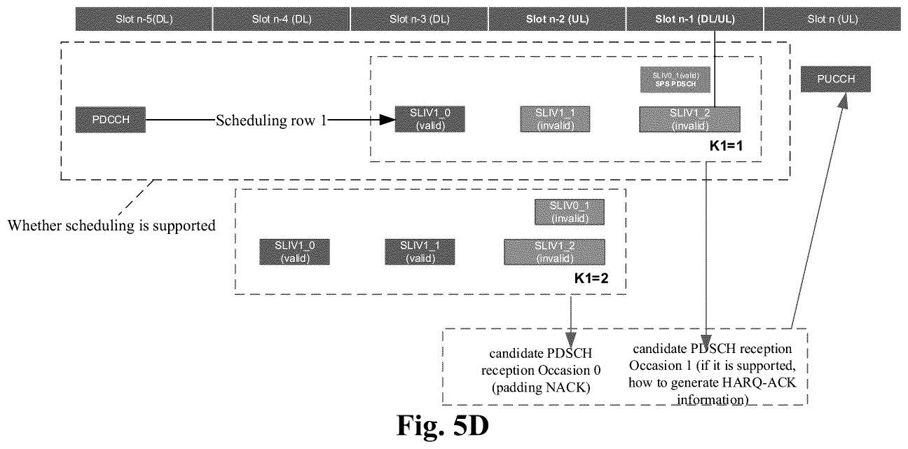

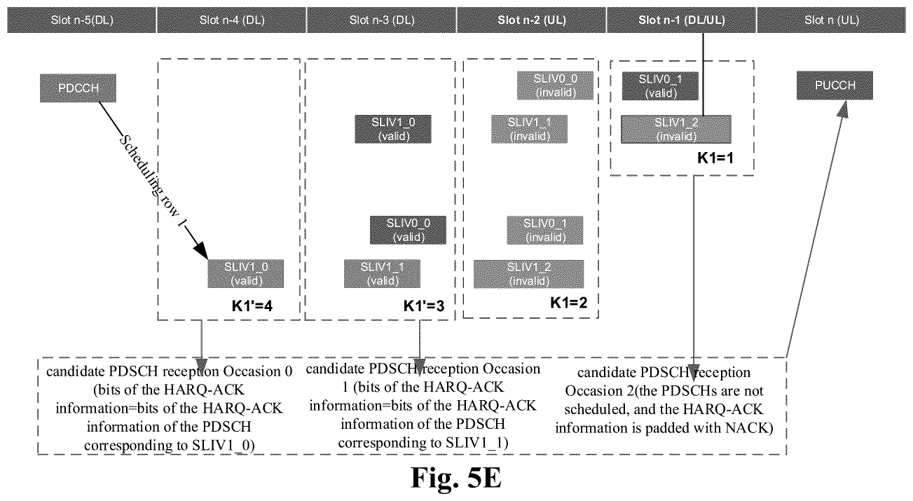

In Rel-17, scheduling more than one PDSCH (multi-PDSCH scheduling) by a single DCI (PDCCH) is supported, and enhancement of HARQ feedback codebooks is still under discussion. For an HARQ feedback codebook (such as a Type-1 HARQ-ACK codebook, or a semi-static HARQ-ACK codebook), time domain bundling may be supported. For example, in a case where time domain bundling is enabled via RRC signaling for a Type-1 HARQ-ACK codebook, in determining a candidate PDSCH reception occasion set, if a row in a TDRA table includes (or corresponds to) an SLIV that does not collide with a semi-statically configured uplink symbol (one row includes one or more SLIVs, wherein at least one SLIV does not collide with the semi-statically configured uplink symbol, that is, the row includes an SLIV that does not conflict with the semi-statically configured uplink symbol), the row is reserved, that is, if at least one row in the TDRA table includes an SLIV that does not collide with the semi-statically configured uplink symbol, a corresponding candidate PDSCH reception occasion is reserved. Furthermore, for a candidate PDSCH reception occasion, in a case of scheduling more than one valid PDSCH by a single DCI, a bit value of HARQ feedback information to which it corresponds is a binary AND of associated valid PDSCHs, the valid PDSCHs being PDSCHs corresponding to a time domain resource configuration (such as an SLIV) which does not collide with the semi-statically configured uplink symbol (or, in other words, a PDSCHs that does not overlap with the semi-statically configured uplink symbol). For example, if there are two associated valid PDSCHs, one of them is not successfully received (NACK/0), and the other one is successfully received (ACK/1), the bit value of the HARQ feedback information is a binary AND of two values, i.e. (NACK/0). As shown in FIG. 5A, for a candidate PDSCH reception occasion, as it is associated with two valid PDSCHs scheduled by the same DCI, a bit value of corresponding HARQ feedback information is a binary AND of HARQ-ACK information bits to which the two PDSCHs correspond.

However, as to the PDSCH scheduling, it is currently not ruled out that there may exist following scheduling situations when time domain bundling is configured, but it is currently not specified how to support HARQ-ACK feedback in these situations. Furthermore, a terminal equipment may possibly not be able to correctly feed back corresponding HARQ-ACK information, resulting in unnecessary retransmission and resource waste.
1. when a candidate PDSCH reception occasion is associated with more than one PDSCH, the more than one PDSCH are scheduled separately by more than one DCI (as shown in FIG. 5C);
2. when a candidate PDSCH reception occasion is associated with more than one PDSCH, the more than one PDSCH are scheduled separately by more than one DCI and SPS (as shown in FIG. 5D); and
3. when a candidate PDSCH reception occasion is associated with more than one valid PDSCH, DCI scheduling one valid PDSCH schedules more than one PDSCH, and there is only one valid PDSCH in the more than one PDSCH (as shown in FIG. 5B). The above problems 1-3 shall be described below with reference to embodiments of the fourth to ninth aspects.

On the other hand, as described above, currently, it is not specified whether/how to support transmitting/receiving more than one PDSCH per slot, and it is not specified a corresponding HARQ feedback method (see embodiments of the first to third aspects for details).

It should be noted that in FIGS. 5A-5E, it is assumed that uplink and downlink subcarrier spacings (subcarrier spacings of PDSCHs and subcarrier spacings of PUCCHs/PUSCHs used for transmitting corresponding HARQ-ACK information) are identical; however, they may also be different. When the uplink and downlink subcarrier spacings are different, one K₁ value may possibly correspond to more than one downlink slot. A downlink slot np in FIGS. 5A-5E refer to a slot corresponding to a downlink subcarrier spacing (or a subcarrier spacing of a PDSCH), wherein specific transmission directions of symbols (downlink/uplink) are not limited. For example, in FIGS. 5A-5E, downlink slots n−1 and n−2 include uplink symbols. In addition, it is assumed in FIGS. 5A-5E that the TDRA table has only two rows, row 0 and row 1, wherein row 0 includes two PDSCH time domain resource configurations, SLIV 0_0 and SLIV 0_1, and row 1 includes three PDSCH time domain resource configurations, SLIV 1_0, SLIV 1_1 and SLIV 1_2, and a K₁ set is {1,2}; however, this disclosure is not limited thereto.

It should be noted that the following embodiments are applicable to a case where ca-SlotOffset is configured and a case where ca-SlotOffset is not configured. The ca-SlotOffset refers to an offset value of different carrier feedback slots, and specific embodiments of the following methods used in these two cases may be identical or different. In addition, embodiments of this disclosure are applicable to FR2-2 (52.6 GHz-71 GHZ); however, it is not limited thereto. In the embodiments of this disclosure, a subcarrier spacing of a PDSCH is 120 kHz, or 480 kHz, or 960 kHz; however, it is not limited thereto.

### EMBODIMENTS OF FIRST ASPECT

The embodiments of this disclosure provide an information feedback method, which shall be described from a terminal equipment side.

FIG. 2 is a schematic diagram of the information feedback method of the embodiments of this disclosure. As shown in FIG. 2, the method includes:
201: a terminal equipment determines a candidate PDSCH reception occasion set according to whether time domain bundling is configured and/or whether multi-PDSCH scheduling is configured and/or a subcarrier spacing of a downlink BWP and/or whether it is capable of receiving more than one PDSCH per slot; and
202: the terminal equipment generates and transmits an HARQ-ACK codebook, the codebook including HARQ-ACK information to which the candidate PDSCH reception occasion set corresponds.

In some embodiments, the terminal equipment needs to perform HARQ-ACK feedback on the received PDSCHs (such as the PDSCHs scheduled by the DCI or SPS PDSCHs) and/or DCI (such as DCI used to deactivate SPS). The HARQ-ACK feedback information may be carried by an HARQ-ACK codebook (such as a Type-1 HARQ-ACK codebook, or being referred to as a semi-static HARQ-ACK codebook), the codebook including bits of HARQ-ACK information of one or more serving cells. How to determine bits of HARQ-ACK information of a serving cell shall be described below. In a case where the codebook includes bits of HARQ-ACK information of multiple serving cells, a method for determining the bits of the HARQ-ACK information of each serving cell is identical to that for determining the bits of the HARQ-ACK information of one serving cell described above, and the bits of the HARQ-ACK information of the multiple serving cells are arranged in a certain order in the codebook, which shall not be repeated herein any further. In the following description, the terms “HARQ-ACK”, “HARQ feedback” and “HARQ-ACK feedback” are interchangeable, and the terms “HARQ-ACK information” and “HARQ-ACK information bits” are interchangeable.

In some embodiments, the codebook includes HARQ-ACK information bits to which a second number (A) of candidate PDSCH reception occasions correspond, the second number being a natural number. The second number (A) of candidate PDSCH reception occasions correspond to the same serving cell (i.e. the above-described serving cell), that is, the second number (A) of candidate PDSCH reception occasions belong to a candidate PDSCH reception occasions set M_{A,C} of the serving cell. In the related art (introduced into Rel-16), in determining the candidate PDSCH reception occasion set, for a downlink slot np, a first allocation table is determined first, the first allocation table including a set of rows (row indices and/or time domain resource configuration (such as an SLIV), etc.) that may possibly be scheduled. If the terminal equipment is unable (has no capability) to receive more than one PDSCH per slot (or, in other words, the terminal equipment does not indicate a capability to receive more than one PDSCH per slot), it is determined to add one candidate PDSCH reception occasion. If the terminal equipment is able (has a capability) to receive more than one PDSCH per slot, it is needed to add one or more candidate PDSCH reception occasions according to the number of mutually independent (completely non-overlapped) time domain resource configurations (such as SLIVs) in the above first allocation table R (or the number of groups of time domain resource configurations (such as the number of groups of SLIVs).

However, in the above method, cases of multi-PDSCH scheduling and/or time domain bundling are not taken into account, wherein the time domain bundling is generally only configured when multi-PDSCH scheduling is configured. In the case where time domain bundling is configured, a row that may possibly be scheduled refers to a row with at least one time domain resource configuration (such as an SLIV) that does not collide with a semi-statically configured uplink symbol. In other words, for example, it is assumed that an initial value of the first allocation table R includes (row indices and/or time domain resource configurations (such as SLIVs), etc. of) all rows, wherein one row corresponds to one or more than one SLIV. For each row therein, if all time domain resource configurations (such as SLIVs) collide with the semi-statically configured uplink symbol, (row indices and/or time domain resource configurations (such as SLIVs), etc. of) the row is excluded/deleted from the first allocation table; otherwise, it is not excluded/deleted. Therefore, an SLIV corresponding to a row in the first allocation table R after deletion may possibly be also cross-slot (the row includes more than one SLIV which are in different slots), and the above existing method is only applicable to that each row includes only one SLIV (as it takes single-PDSCH scheduling only into account), and is not applicable to that one row in the first allocation table corresponds to more than one SLIV. That is, for a case where multi-PDSCH scheduling and/or time domain bundling is/are configured, the above existing method is unable to be used to determine the candidate PDSCH reception occasion set.

In the embodiments of this disclosure, in order to support scheduling more than one PDSCH by a single DCI and correctly feeding back HARQ-ACK information in a case where time domain bundling is configured, in determining the candidate PDSCH reception occasion set, it is needed to take whether time domain bundling is configured and/or whether multi-PDCSH scheduling and/or subcarrier spacings of downlink BWPs are configured into account, which shall be described below in detail.

In some embodiments, before determining the candidate PDSCH reception occasions, the terminal equipment needs to determine HARQ-ACK information feedback timing (i.e., the terminal equipment needs to determine a slot (uplink slot) for transmitting a HARQ-ACK information).

In some embodiments, the terminal equipment receives a DCI. The DCI may include a first information field, which may be a time domain resource allocation domain. The first information field indicates PDSCH time domain resources by indicating an index (a row index, e.g. a value of the row index is greater than or equal to 1) corresponding to the PDSCH TDRA configuration in the PDSCH TDRA table applied by the DCI. In other words, the DCI schedules the PDSCH by indicating the PDSCH TDRA configuration in the PDSCH TDRA table applied thereby, hereinafter referred to as DCI scheduling PDSCH, i.e. the PDSCH indicated by the DCI. For example, the value m of the first information field of the DCI (assuming that m is an integer greater than or equal to 0) corresponds to a PDSCH TDRA configuration with an index m+1 (i.e. an (m+1)-th row) in the PDSCH TDRA table applied by the DCI.

In some embodiments, a PDSCH TDRA table may be predefined, or may be configured via higher-layer signaling. The table supports scheduling more than one PDSCH by a single DCI, or, in other words, one or more than one row in the table include more than one time domain resource configuration (SLIV), such as supporting scheduling more than one PDSCH by a single DCI. However, when the DCI applies the table, if the table further includes one or more than one row including only one time domain resource configuration (an SLIV), the DCI may indicate/schedule one PDSCH (for example, a row of the TDRA table indicated by the first information field in the DCI only includes one SLIV), or indicate/schedule more than one PDSCH (for example, a row of the TDRA table indicated by the first information field in the DCI includes more than one SLIV).

In some embodiments, the above TDRA table is configured by RRC signaling (pdsch-TimeDomainAllocationListForMultiPDSCH-r17 provided in PDSCH-Config), and in a case where the above TDRA table is configured, it is applied to/corresponds to DCI format 1_1.

In some embodiments, the DCI includes a second information field (PDSCH-to-HARQ_feedback timing indicator field) for indicating an HARQ-ACK information feedback occasion k, representing an offset between a feedback slot of the HARQ-ACK information and a slot n where the scheduled PDSCH is located, and the terminal equipment determines a slot needing to transmit HARQ-ACK information according to the second information field.

In some embodiments, the DCI may also not include the second information domain, and the terminal equipment receives second configuration information configured by higher-layer signaling (such as dl-DataToUL-ACK or dl-DataToUL-ACKForDCIFormat1_2 for DCI format 1_2), the second configuration information being used to indicate a HARQ acknowledgement (HARQ-ACK) information feedback occasion k, or, the terminal equipment receives second configuration information configured by higher-layer signaling (such as dl-DataToUL-ACK or dl-DataToUL-ACKForDCIFormat1_2 for DCI format 1_2), the second configuration information being used to configure multiple HARQ acknowledgement (HARQ-ACK) information feedback occasions. The DCI includes the second configuration information, the second information field being used to indicate a HARQ acknowledgement (HARQ-ACK) information feedback occasion k from multiple feedback occasions configured by the second configuration information.

In some embodiments, the HARQ-ACK information (or HARQ-ACK codebook) is carried by a PUCCH or PUSCH. The HARQ-ACK feedback timing shall be described below by taking that the HARQ-ACK information is carried by the PUCCH as an example. Optionally, the PUCCH below may be replaced with a PUSCH, which is not limited in this disclosure. Reference may be made to the related art for how to determine whether a PUCCH or a PUSCH is used.

In some embodiments, HARQ-ACK information corresponding to one or more than one PDSCH scheduled by the DCI may be fed back in the same PUCCH.

For example, the HARQ-ACK information of the more than one PDSCH may be fed back on a PUCCH. Taking that 2^{μ}DE^{-μ}UL=1 as an example, the terminal equipment transmits a HARQ-ACK information at a slot with an index n+k (slot n+k), wherein, a slot with an index n (slot n) is an ending slot of a last PDSCH in the more than one PDSCH, n and k are integers greater than 0, that is, the ending slot of the last PDSCH is n, k is an offset between a feedback slot of the HARQ-ACK information and the slot n, and a relationship between a downlink ending slot n of the PDSCH and an index of its corresponding uplink slot may be determined according to uplink and downlink subcarrier spacings, and reference may be made to the related art, with steps thereof being not going to be repeated herein any further.

In some embodiments, the terminal equipment may determine a candidate PDSCH reception occasion and generate a corresponding codebook after determining a time domain position or a slot where a HARQ-ACK information needs to be fed back. How to determine a candidate PDSCH reception occasion taking no multi-PDSCH scheduling and time domain bundling into account shall be first described below.

In some embodiments, in order to determine a candidate PDSCH reception occasion set, downlink slots that may possibly include (or correspond to) a candidate PDSCH reception occasion need to be determined.

In some embodiments, the downlink slot is determined according to a slot timing value K₁.

For example, for a slot needing to transmit a HARQ-ACK information, such as an uplink slot nu, according to a slot timing value K₁ set associated with an active uplink bandwidth part (UL BWP), one or more downlink slots np to which each K₁ in the K₁ set corresponds may be respectively determined, wherein, K₁ denotes an offset value of a PDSCH relative to a HARQ-ACK information feedback slot n_{D} (i.e. a value k possibly indicated in the DCI). In determining one or more downlink slots to which each K₁ corresponds, optionally, subcarrier spacings between uplink and downlink bandwidth parts need to be taken into account, and one K₁ may possibly correspond to multiple downlink slots. Reference may be made to the related art, and the embodiments of this disclosure is not limited thereto. A subcarrier spacing of a downlink bandwidth part (DL BWP) refers to, for example, a subcarrier spacing of an active DL BWP (or a subcarrier spacing of a PDSCH that needs to feed back a HARQ-ACK information at the above uplink slot), and a subcarrier spacing of an uplink bandwidth part (UL BWP) refers to, for example, a subcarrier spacing of a (active) UL BWP used for transmitting the above HARQ-ACK information (or a subcarrier spacing of a PUCCH or PUSCH used for transmitting the HARQ-ACK information).

In some embodiments, reference may be made to the related art in determining the K₁ set associated with an active uplink bandwidth part (UL BWP).

For example, for a downlink slot, the first allocation table (including a set of rows that may possibly be scheduled, each row includes row indices and/or SLIVs, etc.) is determined first, and whether there is a corresponding candidate PDSCH reception occasion in the slot is determined, thereby determining a candidate PDSCH reception occasion set. It should be noted that the determinations of the downlink slots and the PDSCH time domain resource configuration to which the slots correspond may be executed sequentially or simultaneously, and this disclosure is not limited thereto.

How to determine a first allocation table shall be described below first. The first allocation table is used to determine a candidate PDSCH reception occasion and/or is used to schedule PDSCHs.

In some embodiments, the PDSCH TDRA configuration and/or an index to which the configuration corresponds may be included in a first allocation table. For example, the first allocation table may be determined according to PDSCH TDRA tables that may be applied by the DCI formats, and the first allocation table is also associated with an active DL BWP. For example, for a serving cell c, a row (row index and/or corresponding SLIV configuration, etc.) in an initial first allocation table corresponds to a row of TDRA configuration in a union of time domain resource allocation tables of DCI formats needing to be monitored configured by the terminal equipment on the serving cell c. For another example, the first allocation table may include a union of all rows in PDSCH TDRA tables applied by the DCI formats needing to be monitored, and configuration of each row is identical to that in the PDSCH TDRA table. For example, for a specific active DL BWP, Table 1 is a table of examples of the first allocation table. As shown in Table 1, a PDSCH TDRA configuration (corresponding to a row in the first allocation table); moreover, a PDSCH TDRA configuration may (optionally) include slot offset K0 configuration, K0 denoting a slot offset between a PDSCH and a PDCCH; and furthermore, a PDSCH TDRA configuration may include other information (such as a mapping mode), configuration of the other information being included or not included in the PDSCH time domain resource configuration. In addition, if the terminal equipment is configured with ReferenceofSLIV-ForDCIFormat1_2, a new row needs to be added on the basis of a PDSCH TDRA table of DCI_format1_2, which shall not be enumerated herein any further, and reference may be made to the related art for details.

TABLE 1

| | | | |
|---|---|---|---|
| R (Row | | start and length | PDSCH |
| index) | K₀ | indicators SLIV | mapping type |

In some embodiments, if the terminal equipment is unable (has no capability) to receive more than one PDSCH per slot (or, in other words, the terminal equipment does not indicate a capability to receive more than one PDSCH per slot), it is determined to add one candidate PDSCH reception occasion. If the terminal equipment is able (has a capability) to receive more than one PDSCH per slot, it is needed to add one or more than one candidate PDSCH reception occasion according to the number of mutually independent (completely non-overlapped) time domain resource configurations (such as SLIVs) in the above first allocation table R (or the number of groups of time domain resource configurations (such as the number of groups of SLIVs).

How to determine a candidate PDSCH reception occasion taking no multi-PDSCH scheduling and time domain bundling into account is described above, and on this basis, how to determine a candidate PDSCH reception occasion when multi-PDSCH scheduling and time domain bundling are configured shall be described below. In the following description, differences shall only be described, and repeated parts shall not be described any further. In some embodiments, it may be predefined and/or configured by RRC signaling that the terminal equipment monitors/detects/receives one or more than one DCI format. TDRA tables applied by different DCI formats/to which different DCI formats correspond are identical or different. For example, one or more than one row in a TDRA table applied by DCI format 1_1 include more than one SLIV (and it may also be that one or more than one rows include only one SLIV), and each row in the TDRA table applied by DCI format 1_0 or DCI format 1_1 respectively includes only one SLIV.

In some embodiments, in a case where multi-PDSCH scheduling is configured but time domain bundling is not configured, one or more than one row in the first allocation table include/correspond to more than one SLIV. The first allocation table may be processed so that one row in the processed first allocation table (hereinafter referred to as a third allocation table) corresponds to one SLIV. A candidate PDSCH reception occasion is determined based on the third allocation table, which shall be described below with reference to FIG. 5E. FIG. 5E is a schematic diagram of the candidate PDSCH reception occasion. As shown in FIG. 5E, it is assumed that the first allocation table has only/corresponds to two rows, row 0 and row 1, wherein row 0 includes two PDSCH time domain resource configurations, SLIV 0_0 and SLIV 0_1, and row 1 includes three PDSCH time domain resource configurations, SLIV 1_0, SLIV 1_1 and SLIV 1_2, and it is split to obtain a third allocation table, in which each row corresponds to SLIV 0_0, SLIV 0_1, SLIV 1_0, SLIV 1_1 and SLIV 1_2; for the HARQ feedback slot nu, a K1 set includes {1,2}, and may further include {3,4} after being extended according to the first allocation table (before being processed), wherein for a downlink Slot n−2, symbols therein are all uplink symbols (semi-static configurations), while in downlink Slot n−1, a part of symbols are uplink (UL) symbols, a part of symbols are downlink (DL) symbols. Hence, for Slot n−1 (corresponding to K1=1), in a corresponding row in the third allocation table, SLIV0_1 is a valid PDSCH/SLIV, for Slot n−2 (corresponding to K1=2), in a corresponding row in the third allocation table, there exists no valid PDSCH/SLIV, for Slot n−3 (corresponding to K1′=3), in a corresponding row in the third allocation table, SLIV0_1 and SLIV 1_1 are valid PDSCHs/SLIVs, and for Slot n−4 (corresponding to K1′=4), in a corresponding row in the third allocation table, SLIV 0_1 is a valid PDSCH/SLIV, and there exist a candidate PDSCH reception occasion 2 corresponding to Slot n−1 (corresponding to K1=1), a candidate PDSCH reception occasion 1 corresponding to Slot n−3 (corresponding to K1′=3) and a candidate PDSCH reception occasion 0 corresponding to Slot n−4 (corresponding to K1′=4), respectively. In some embodiments, in a case where time domain bundling is configured (which may generally only be configured when multi-PDSCH scheduling is configured), one or more than one row in the first allocation table include/correspond to more than one SLIV. The first allocation table may be processed according to whether SLIVs of each row collide with the semi-statically configured uplink symbol. The first allocation table after being processed as such is referred to as a second allocation table. For example, for each row therein, if all time domain resource configurations (such as SLIVs) collide with the semi-statically configured uplink symbol, (a row index and/or time domain resource configuration (such as SLIVs) of) the row is excluded/deleted from the first allocation table. That is, in the case where time domain bundling is configured, a row that may possibly be scheduled refers to a row with at least one SLIV that does not collide with the semi-statically configured uplink symbol. Therefore, the second allocation table does not include a row satisfying the following conditions, and all SLIVs to which the row corresponds collide with the semi-statically configured uplink symbol. If at least one row in the second allocation table includes/corresponds to an SLIV that does not collide with the semi-statically configured uplink symbol, a corresponding candidate PDSCH reception occasion is reserved. FIG. 5A is a schematic diagram of the candidate PDSCH reception occasion. As shown in FIG. 5A, it is assumed that the first allocation table has only two rows, row 0 and row 1, wherein row 0 includes two PDSCH time domain resource configurations, SLIV 0_0 and SLIV 0_1, and row 1 includes three PDSCH time domain resource configurations, SLIV 1_0, SLIV 1_1 and SLIV 1_2. After comparison, the two rows are reserved in the first allocation table, and the second allocation table (that is, it is identical to the first allocation table) is obtained; and for the HARQ feedback slot nᵤ, the K1 set includes {1,2}, wherein symbols in the downlink Slot n−2 are all uplink symbols (semi-static configurations), a part of symbols in the downlink Slot n−1 are uplink symbols, a part of symbols therein are downlink (DL) symbols, and symbols in remaining slots are all downlink (DL) symbols. Hence, for Slot n−1 (corresponding to K1=1), SLIV0_1 and SLIV1_0 are valid PDSCHs, and for Slot n−2 (corresponding to K1=2), SLIV0_0, SLIV1_0 and SLIV1_1 are valid PDSCHs. Hence, there exist a candidate PDSCH reception occasion 1 corresponding to Slot n−1 (corresponding to K1=1) and a candidate PDSCH reception occasion 0 corresponding to Slot n−2 (corresponding to K1=2), respectively.

In some embodiments, for each downlink slot, a corresponding candidate PDSCH reception occasion is determined according to the first allocation table and the second allocation table.

Therefore, whether a slot has a corresponding candidate PDSCH reception occasion is determined according to whether time domain bundling is configured and/or whether it has a capability to receive more than one PDSCH per slot. For example, when time domain bundling is configured or when the terminal equipment does not have a capability to receive more than one PDSCH per slot, one PDSCH reception occasion is added; and when time domain bundling is not configured and the terminal equipment has a capability to receive more than one PDSCH per slot, one candidate PDSCH reception occasion or multiple candidate PDSCH reception occasions is/are added to the candidate PDSCH reception occasion set according to the number of mutually independent PDSCH time domain resource configurations in a first allocation table, which shall be described below in detail.

For example, when time domain bundling is configured, or when the terminal equipment has no capability to receive more than one PDSCH per slot, one PDSCH reception occasion is added. For example, when time domain bundling is configured, it means that an allocation table used to determine the candidate PDSCH reception occasion is a second allocation table, which shall be exemplified below with reference to a pseudo code Pseudocode.

```
if the UE is provided enable Time DomainHARQ-Bundling or the
UE does not
indicate a capability to receive more than one unicast PDSCH or
multicast PDSCH
per slot, and R ≠ Ø,
  M_{A,c} = M_{A,c} ∪ j;
  j = j + 1;
```

That is, in a case where the second allocation table is not empty, when the terminal equipment is configured with time domain bundling or when the terminal equipment has no capability to receive more than one PDSCH per slot, one PDSCH reception occasion (j=j+1) is added to the candidate PDSCH reception occasion set M_{A,C}.

Otherwise, when no time domain bundling is configured and the terminal equipment has a capability to receive more than one PDSCH per slot, one candidate PDSCH reception occasion or multiple candidate PDSCH reception occasions is/are added to the candidate PDSCH reception occasion set according to the number of mutually independent PDSCH time domain resource configurations in the first allocation table, which shall be exemplified below with reference to a pseudo code Pseudocode.

```
if the UE is not provided enable TimeDomainHARQ-Bundling and the
UE indicate a
capability to receive more than one unicast PDSCH or multicast PDSCH
per slot,
and R ≠ Ø,
  Set C(R) to the cardinality of RSet m to the smallest last OFDM symbol
  index, as determined by the SLIV, among all rows of R
  while R ≠ Ø
    Set r = 0
    while r < C(R)
      if S ≤ m for start OFDM symbol index S for row r
        b_{r,k,n}_{ₙ}= j; - index of occasion for candidate PDSCH reception,
        or SPS
        PDSCH release, or TCI state update associated with row r
        R = R\r;
        B = B ∪ b_{r,k,n}_{ₙ};
      else
        r = r + 1;
      end if
    end while
    M_{A,c} = M_{A,c} ∪ j;
    j = j + 1;
    Set m to the smallest last OFDM symbol index among all rows of R;
  end while
end if
```

That is, for each row in the third allocation table (that is not empty), adding one or more than one candidate PDSCH reception occasion is sequentially determined according to the number of independent (completely non-overlapped) SLIVs or the number of SLIV groups to which each row corresponds.

In some embodiments, in determining the PDSCH reception occasion set, the terminal equipment may further take whether to configure multi-PDCSH scheduling and/or a subcarrier spacings of a downlink BWP into account.

In some embodiments, some subcarrier spacings (such as 120 kHz) support scheduling more than one PDSCH per slot, and some subcarrier spacings (such as 480/960 kHz) do not support scheduling more than one PDSCH per slot. In a case where a subcarrier spacing of a downlink BWP=120 kHz, if multi-PDSCH scheduling is configured, after determining an allocation table (a second allocation table) that only includes rows corresponding to schedulable TDRA configurations, the above method is adopted (i.e. determining the PDSCH reception occasion set according to whether time domain bundling is configured), and in a case where a subcarrier spacing of a downlink BWP=480/960 kHz, the above method needs not to be adopted (i.e. needing not to determine the PDSCH reception occasion set according to whether time domain bundling is configured).

In some embodiments, the above methods for determining the candidate PDSCH reception occasions may be implemented separately or in a combined manner, and the embodiments of this disclosure is not limited thereto.

In some embodiments, in 202, after determining the candidate PDSCH reception occasion set, an HARQ-ACK codebook including a HARQ-ACK information to which the candidate PDSCH reception occasion set corresponds is further generated. How to generate the codebook according to the candidate PDSCH reception occasion set shall be described below.

In some embodiments, a size of the codebook does not dynamically vary with an actual data scheduling situation, but is determined according to a preconfigured (e.g. configured by higher-layer signaling) or predefined parameter. How to determine HARQ-ACK information bits of a serving cell shall be described below only.

In some embodiments, the number of HARQ-ACK information bits to which a candidate PDSCH reception occasion of a serving cell corresponds is related to a cell's configured HARQ spatial bundling parameter (harq-ACK-SpatialBundlingPUCCH), code block group (CBG) configuration parameter (PDSCH-CodeBlockGroupTransmission) and supported maximum codeword parameter (maxNrofCodeWordsScheduledByDCI), as shown in Table 2 below in which that the HARQ-ACK information is fed back on a PUCCH is taken as an example:

TABLE 2

| | PDSCH- | | HARQ-ACK |
|---|---|---|---|
| | CodeBlock | maxNrofCodeWords | information bits for a |
| harq-ACK-Spatial | GroupTrans- | ScheduledByDCI = | candidate PDSCH |
| BundlingPUCCH | mission | 2 | reception occasion |
| No | No | yes | 2 bits, for a transport |
| | | | block (TB) |
| yes | / | yes | 1 bit |
| / | yes | yes | 2* N_{HARQ-ACK, c}^{CBG/TB, max} bits, |
| | | | each N_{HARQ-ACK, c}^{CBG/TB, max} |
| | | | bits for a TB |
| / | yes | yes | N_{HARQ-ACK, c}^{CBG/TB, max} bits |
| No | No | No | 1 bit |

What described above is illustrative only, and modes for determining the number of HARQ-ACK information bits corresponding to the candidate PDSCH reception occasion of a serving cell is not limited thereto, and a mode for determining bit values of information in the HARQ-ACK codebook is not limited in this disclosure. For example, the related art may be used (for example, existing methods for determining HARQ-ACK information in a case where time domain bundling is configured or a case where time domain bundling is not configured are all applicable), or they may be determined according to embodiments of the fourth to ninth aspects described later.

In some embodiments, the HARQ-ACK information bits corresponding to the candidate PDSCH reception occasions are arranged in an order of a second number of candidate PDSCH reception occasions in the candidate PDSCH reception occasion set, so as to obtain HARQ-ACK information bits of a serving cell. If a candidate PDSCH reception occasion does not have a corresponding (or associated) PDSCH, bits of HARQ-ACK information to which it corresponds are padded with NACK. As described above, in the case where the codebook includes the HARQ-ACK information bits of a serving cell, the HARQ-ACK information bits of the serving cell are taken as codebooks for feedback. In the case where the codebook includes the HARQ-ACK information bits of multiple serving cells, a method for determining HARQ-ACK information bits of each serving cell is identical to that for determining HARQ-ACK information bits of one serving cell. However, in specific determination, such other parameters as PDSCH TDRA configurations to which each serving cell corresponds may be identical or different. For example, the above parameters may possibly be configured separately for the serving cells; however, the embodiments are not limited thereto. The HARQ-ACK information bits to which the serving cells correspond may be arranged in an ascending order of indices of the serving cells, so as to generate codebooks for feedback.

In some embodiments, the terminal equipment may receive enable time domain bundling configuration information transmitted by the network device. For example, the enable time domain bundling configuration information (enableTimeDomainHARQ-Bundling) is carried by RRC signaling. When the enable time domain bundling configuration information is received, it indicates that the terminal equipment is configured with time domain bundling.

It can be seen from the above embodiments that in the case where scheduling more than one PDSCH by a single DCI and time domain bundling are supported, more than one PDSCH may be transmitted/received per slot, and corresponding HARQ-ACK information feedback may be performed. Hence, the network device and the terminal equipment may have identical understandings of whether the above PDSCH scheduling is allowed, and if the above situations occur when the network device schedules the PDSCHs, the terminal equipment may be able to correctly receive the scheduled PDSCHs and/or feed back corresponding HARQ-ACK information, thereby avoiding unnecessary retransmission and resource waste.

### EMBODIMENTS OF SECOND ASPECT

By implementing the method in the embodiments of the first aspect, in the case where scheduling more than one PDSCH by a single DCI and/or time domain bundling are supported, more than one PDSCH may be transmitted/received per slot, and corresponding HARQ-ACK information feedback may be performed. On the other hand, in the embodiments of the second aspect, when the terminal equipment has a capability to receive more than one PDSCH per slot, the network device does not configure multi-PDSCH scheduling and/or time domain bundling. In the embodiments, transmitting/receiving more than one PDSCH per slot is not supported, which shall be described below in detail.

The embodiments of this disclosure provide a scheduling configuration method, which shall be described from a network device side.

FIG. 3 is a schematic diagram of the scheduling configuration method of the embodiments of this disclosure. As shown in FIG. 3, the method includes:
301: a network device receives, capability indication information transmitted by a terminal equipment, the capability indication information being used to indicate that the terminal equipment is capable of receiving more than one PDSCH per slot; and
302: the network device does not transmit enable time domain bundling configuration information to the terminal equipment and/or not transmit first indication information configuring a PDSCH time domain resource allocation table to the terminal equipment.

In some embodiments, in 301, when the network device receives a capability indication information, it indicates that the terminal equipment may (has a capability) to receive more than one PDSCH per slot (or, in other words, the terminal equipment indicates a capability to receive more than one PDSCH per slot), in which case the network device is unable to configure multi-PDSCH scheduling and/or time domain bundling, that is, the network device does not transmit enable time domain bundling configuration information and/or first indication information configuring a PDSCH time domain resource allocation table to the terminal equipment. That is, only when the network device does not receive the capability indication information (the terminal equipment is unable (does not have a capability) to receive more than one PDSCH per slot), the network device may configure multi-PDSCH scheduling and/or time domain bundling, that is, the network device may transmit the enable time domain bundling configuration information and/or the first indication information configuring the PDSCH time domain resource allocation table to the terminal equipment.

For example, if the terminal equipment is able (has a capability) to receive more than one PDSCH per slot (or, in other words, if the terminal equipment indicates a capability to receive more than one PDSCH per slot), the network device is unable to configure multi-PDSCH scheduling and/or time domain bundling. That is, the network device does not transmit the first indication information and/or the enable time domain bundling information.

For another example, if the terminal equipment is able (has a capability) to receive more than one PDSCH per slot (or, in other words, if the terminal equipment indicates a capability to receive more than one PDSCH per slot) and the network device configures multi-PDSCH scheduling, the network device is unable to configure time domain bundling. That is, the network device transmits the first indication information, but does not transmit the enable time domain bundling information.

In some embodiments, the network device carries the enable time domain bundling configuration information (enableTimeDomainHARQ Bundling) via RRC signaling, and when the enable time domain bundling configuration information is received, it indicates that the terminal equipment is configured with time domain bundling. If the network device does not transmit the enable time domain bundling configuration information, it indicates that the terminal equipment is not configured with time domain bundling.

In some embodiments, the network device carries the first indication information pdsch TimeDomainAllocationListForMultipaDSCH via RRC signaling, the first indication information being used to configure a time domain resource allocation table that supports scheduling more than one PDSCH by a single DCI. When the first indication information is received, it indicates that the terminal equipment is configured with multi-PDSCH scheduling. If the network device does not transmit the first indication information, it indicates that the terminal equipment is not configured with multi-PDSCH scheduling.

In some embodiments, when the time domain resource allocation table supporting scheduling more than one PDSCH by single DCI is configured, the TDRA table is applied to/corresponds to DCI format 1_1.

It can be seen from the above embodiments that it is specified that transmitting/receiving more than one PDSCH is not supported in the case where scheduling more than one PDSCH by a single DCI and/or time domain bundling configuration is/are supported, thereby preventing the terminal equipment from being unable to receive and/or feed back corresponding HARQ-ACK information while the network device transmits more than one PDSCH per slot in the case where scheduling more than one PDSCH by a single DCI and/or time domain bundling configuration is/are supported, and avoiding unnecessary retransmission and resource waste.

### EMBODIMENTS OF THIRD ASPECT

The embodiments of this disclosure provide a scheduling configuration method, which shall be described from a terminal equipment side, with parts repeated with those in the embodiments of the second aspect being not going to be described herein any further.

FIG. 4 is a schematic diagram of the scheduling configuration method of the embodiments of this disclosure. As shown in FIG. 4, the method includes:
401: a terminal equipment transmits capability indication information to a network device, the capability indication information being used to indicate that the terminal equipment is capable of receiving more than one PDSCH per slot; and
402: the terminal equipment does not receive enable time domain bundling configuration information configured by the network device and/or does not receive first indication information of a PDSCH time domain resource allocation table configured by the network device.

In some embodiments, implementations of 401-402 correspond to those of 301-302 in the embodiments of the second aspect, and repeated part shall not be described herein any further.

In some embodiments, when the terminal equipment is able (has a capability) to receive more than one PDSCH per slot (or, in other words, when the terminal equipment indicates a capability to receive more than one PDSCH per slot), the network device is unable to configure multi-PDSCH scheduling and/or time domain bundling for the terminal equipment. That is, in such a case, the terminal equipment does not receive (does not be expected to receive) the enable time domain bundling configuration information and/or the first indication information configuring the PDSCH time domain resource allocation table transmitted by the network device. That is, only when the terminal equipment is unable (has not capability) to receive more than one PDSCH per slot, may the network device configure multi-PDSCH scheduling and/or time domain bundling for the terminal equipment. That is, the terminal equipment may possibly receive the enable time domain bundling configuration information and/or the first indication information configuring the PDSCH time domain resource allocation table transmitted by the network device.

For example, if the terminal equipment is able (has a capability) to receive more than one PDSCH per slot (or, in other words, if the terminal equipment indicates a capability to receive more than one PDSCH per slot), the terminal equipment is not configured with multi-PDSCH scheduling and/or time domain bundling by the network device, that is, it does not receive the enable time domain bundling configuration information and/or the first indication information.

For another example, if the terminal equipment is able (has a capability) to receive more than one PDSCH per slot (or, in other words, if the terminal equipment indicates a capability to receive more than one PDSCH per slot) and is configured with multi-PDSCH scheduling, the terminal equipment is not configured with time domain bundling by the network device. That is, the terminal equipment receives the first indication information, but does not receive the enable time domain bundling configuration information.

Reference may be made to the embodiments of the second aspect for implementations of the enable time domain bundling configuration and the first indication information, which shall not be repeated herein any further.

In some embodiments, in the case where the network device configures multi-PDSCH scheduling and/or time domain bundling, the method may further include: the terminal equipment determines a candidate PDSCH reception occasion set and generates a corresponding HARQ feedback codebook, wherein an existing method for determining a candidate PDSCH reception occasion set in Rel-17 may be reused, or the method for determining the candidate PDSCH reception occasion set in the embodiments of the first aspect may be used, and a specific method is as described above, which shall not be repeated herein any further. In addition, an existing method in Rel-17 may be reused for generating the corresponding HARQ feedback codebook, or, the method in the embodiments of the sixth aspect may be used, which shall not be repeated herein any further.

It can be seen from the above embodiments that it is specified that transmitting/receiving more than one PDSCH is not supported in the case where scheduling more than one PDSCH by a single DCI and/or time domain bundling configuration is/are supported, thereby preventing the terminal equipment from being unable to receive and/or feed back corresponding HARQ-ACK information while the network device transmits more than one PDSCH per slot in the case where scheduling more than one PDSCH by a single DCI and/or time domain bundling configuration is/are supported, and avoiding unnecessary retransmission and resource waste.

It should be noted that FIGS. 2-4 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIGS. 2-4.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

### EMBODIMENTS OF FOURTH ASPECT

The embodiments of this disclosure provide a scheduling configuration method, which shall be described from a network device side.

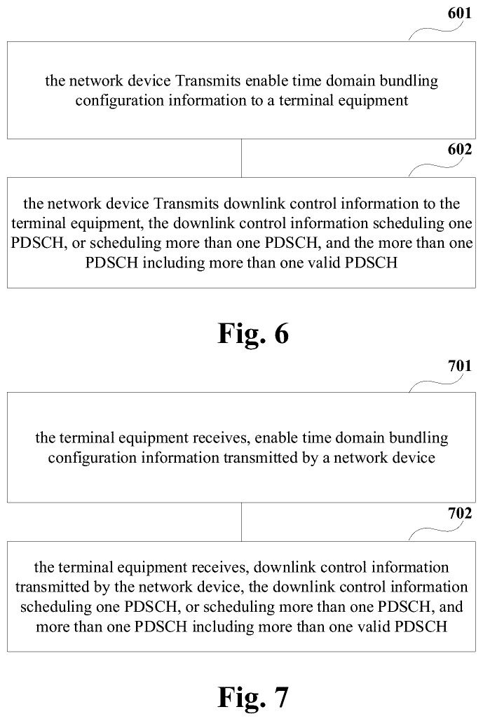

FIG. 6 is a schematic diagram of the scheduling configuration method of the embodiments of this disclosure. As shown in FIG. 6, the method includes:
601: a network device transmits enable time domain bundling configuration information to a terminal equipment; and
602: the network device transmits downlink control information by to the terminal equipment, the downlink control information scheduling one PDSCH, or scheduling more than one PDSCH, and the more than one PDSCH including more than one valid PDSCH.

In some embodiments, in 601, the network device carries the enable time domain bundling configuration information (enableTimeDomainHARQ-Bundling) via RRC signaling, and when the enable time domain bundling configuration information is received, it indicates that the terminal equipment is configured with time domain bundling.

In some embodiments, in 602, the DCI may include a first information field, which may be a time domain resource allocation field. The first information field indicates PDSCH time domain resources by indicating an index (a row index, e.g. a value of the row index is greater than or equal to 1) corresponding to the PDSCH TDRA configuration in the PDSCH TDRA table applied by the DCI. In other words, the DCI schedules the PDSCH by indicating the PDSCH TDRA configuration in the PDSCH TDRA table applied thereby, hereinafter referred to as DCI scheduling PDSCH, i.e. the PDSCH indicated by the DCI. For example, the value m of the first information field of the DCI (assuming that m is an integer greater than or equal to 0) corresponds to indicate a PDSCH TDRA configuration with an index m+1 (i.e. an (m+1)-th row) in the PDSCH TDRA table applied by the DCI.

In some embodiments, the PDSCH TDRA table may be predefined, or may be configured via higher-layer signaling. The table supports scheduling more than one PDSCH by a single DCI, or, in other words, one or more than one rows in the table include more than one time domain resource configuration (SLIV), such as supporting scheduling more than one PDSCH by a single DCI in the case where time domain bundling is configured (the case of transmitting enable time domain bundling configuration information in 601). However, when the DCI applies the table, it may indicate/schedule one PDSCH (for example, a row of the TDRA table indicated by the first information field in the DCI only includes one SLIV), or indicate/schedule more than one PDSCH (for example, a row of the TDRA table indicated by the first information field in the DCI includes more than one SLIV), and there are more than one valid PDSCH therein, in other words, the DCI is unable to indicate/schedule more than one PDSCH in which there is only one valid PDSCH. That is, the network device does not transmit the DCI indicating/scheduling more than one PDSCH in which there is only one valid PDSCH to the terminal equipment.

It can be seen from the above embodiments that indicating/scheduling multiple PDSCHs by a physical downlink control channel (PDCCH) is not supported and there is only one valid PDSCH in the case where time domain bundling is configured, thereby preventing the terminal equipment from being unable to receive and/or feed back corresponding HARQ-ACK information while a base station indicates/schedules multiple PDSCHs via a physical downlink control channel (PDCCH) and there is only one valid PDSCH in the case where time domain bundling configuration is supported, and avoiding unnecessary retransmission and resource waste.

### EMBODIMENTS OF FIFTH ASPECT

The embodiments of this disclosure provide a scheduling configuration method, which shall be described from a terminal equipment side, with parts repeated with those in the embodiments of the fourth aspect being not going to be described herein any further.

FIG. 7 is a schematic diagram of the scheduling configuration method of the embodiments of this disclosure. As shown in FIG. 7, the method includes:
701: a terminal equipment receives, enable time domain bundling configuration information transmitted by a network device; and
702: the terminal equipment receives, downlink control information transmitted by the network device, the downlink control information scheduling one PDSCH, or scheduling more than one PDSCH, and more than one PDSCH including more than one valid PDSCH.

In some embodiments, implementations of 701-702 correspond to those of 601-602 in the embodiments of the fourth aspect, and repeated part shall not be described herein any further.

In some embodiments, in a case where time domain bundling is configured (the enable time domain bundling configuration information is received in 701), the DCI indicates/schedules only one PDSCH (e.g. a row in the TDRA table indicated by the first information field in the DCI includes only one SLIV), or it may indicate/schedule more than one PDSCH (e.g. the row in the TDRA table indicated by the first information field in the DCI includes more than one SLIV), and there are more than one valid PDSCH therein, in other words, the DCI is unable to indicate/schedule more than one PDSCH, and there is only one valid PDSCH therein, that is, the terminal equipment does not receive (is not expected to receive) the DCI indicating/scheduling more than one PDSCH with only one valid PDSCH therein.

In some embodiments, in the case where the network device configures time domain bundling, the method may further include: the terminal equipment determines a candidate PDSCH reception occasion set and generates a corresponding HARQ feedback codebook, wherein an existing method for determining a candidate PDSCH reception occasion set in Rel-17 may be reused, or the method for determining the candidate PDSCH reception occasion set in the embodiments of the first aspect may be used, and a specific method is as described above, which shall not be repeated herein any further. In addition, an existing method in Rel-17 may be reused for generating the corresponding HARQ feedback codebook, or, the method in the embodiments of the sixth aspect may be used, which shall not be repeated herein any further.

It can be seen from the above embodiments that indicating/scheduling multiple PDSCHs by a physical downlink control channel (PDCCH) and there is only one valid PDSCH is not supported in the case where time domain bundling is configured, thereby preventing the terminal equipment from being unable to receive and/or feed back corresponding HARQ-ACK information while a base station indicates/schedules multiple PDSCHs via a physical downlink control channel (PDCCH) and there is only one valid PDSCH in the case where time domain bundling configuration is supported, and avoiding unnecessary retransmission and resource waste.

### EMBODIMENTS OF SIXTH ASPECT

With the method in the embodiments of the fourth and fifth aspect, in the case where time domain bundling is configured, indicating/scheduling multiple PDSCHs with only one valid PDSCH therein by a physical downlink control channel (PDCCH) is not supported. On the other hand, in the embodiments of the sixth aspect, in a case where time domain bundling is configured, indicating/scheduling multiple PDSCHs with only one valid PDSCH therein by a physical downlink control channel (PDCCH) is supported, whether/how to support associating multiple PDSCHs for a candidate PDSCH reception occasion and scheduling the multiple PDSCHs by different DCI or in different manners is specified, and corresponding HARQ-ACK information feedback is performed, which shall be described below in detail.

The embodiments of this disclosure provide an information feedback method, which shall be described from a terminal equipment side.

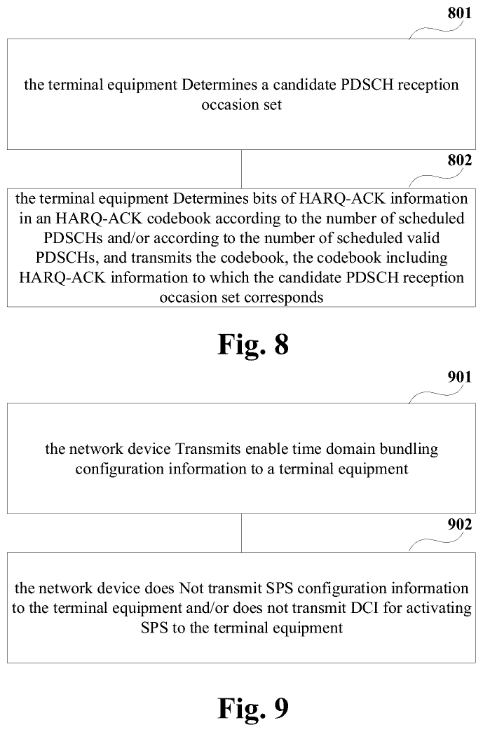

FIG. 8 is a schematic diagram of the information feedback method of the embodiments of this disclosure. As shown in FIG. 8, the method includes:
801: the terminal equipment determines a candidate PDSCH reception occasion set; and
802: the terminal equipment determines bits of HARQ-ACK information in an HARQ-ACK codebook according to the number of scheduled PDSCHs and/or according to the number of scheduled valid PDSCHs, and transmits the codebook, the codebook including HARQ-ACK information to which the candidate PDSCH reception occasion set corresponds.

In some embodiments, in 801, the terminal equipment may reuse an existing method for receiving a candidate PDSCH reception occasion set in Rel-17, or may use the method for receiving the candidate PDSCH reception occasion set in the embodiments of the first aspect, and a specific method is as described above, which shall not be repeated herein any further.

In some embodiments, in determining the candidate PDSCH reception occasion set, the HARQ-ACK information bits corresponding to each candidate PDSCH reception occasion are arranged in an order of a second number of candidate PDSCH reception occasions in the candidate PDSCH reception occasion set, so as to obtain HARQ-ACK information bits of a serving cell. As described above, in the case where the codebook includes the HARQ-ACK information bits of a serving cell, the HARQ-ACK information bits of the serving cell are taken as codebooks for feedback. In the case where the codebook includes the HARQ-ACK information bits of multiple serving cells, a method for determining HARQ-ACK information bits of each serving cell is identical to that for determining HARQ-ACK information bits of one serving cell. However, in specific determination, such other parameters as PDSCH TDRA configurations to which the serving cells correspond may be identical or different. For example, the above parameters may possibly be configured separately for each serving cell; however, the embodiments are not limited thereto. The HARQ-ACK information bits to which the serving cells correspond may be arranged in an ascending order of indices of the serving cells, so as to generate codebooks for feedback.

In some embodiments, the PDSCHs scheduled in 802 include PDSCHs scheduled by the DCI and/or SPS.

How to determine bit values of a HARQ-ACK information to which the candidate PDSCH reception occasion corresponds shall be described below for a candidate PDSCH reception occasion.

In some embodiments, for a candidate PDSCH reception occasion in the candidate PDSCH reception occasion set, the terminal equipment determines bits of HARQ-ACK information to which a candidate PDSCH reception occasion corresponds according to the number of associated scheduled PDSCHs and/or the number of associated valid PDSCHs with the candidate PDSCH reception occasion.

In some embodiments, when the number of associated scheduled PDSCHs and/or the number of associated valid PDSCHs with the candidate PDSCH reception occasion is/are 1, the bits of the HARQ-ACK information to which the candidate PDSCH reception occasion corresponds are equal to the bits of HARQ-ACK information to which the associated scheduled PDSCHs and/or the associated valid PDSCHs correspond(s).

In some embodiments, when the number of associated scheduled PDSCHs and/or the number of associated valid PDSCHs with the candidate PDSCH reception occasion is/are greater than 1, the bits of the HARQ-ACK information to which the candidate PDSCH reception occasion corresponds are equal to a binary AND of bits of HARQ-ACK information to which the associated scheduled PDSCHs and/or the associated valid PDSCHs correspond(s).

Hence, indicating/scheduling more than one PDSCH with only one valid PDSCH therein by a physical downlink control channel (PDCCH) is supported.

In some embodiments, a PDSCH or a valid PDSCH with which the same candidate PDSCH reception occasion is associated is scheduled by the same DCI. For example, when the number of valid PDSCHs associated with the same candidate PDSCH reception occasion is greater than one, the more than one valid PDSCH is all scheduled by the same DCI. That is, associating multiple PDSCHs for a candidate PDSCH reception occasion and scheduling the multiple PDSCHs by different DCI or in different manners are not supported.

For example, for a candidate PDSCH reception occasion, if the terminal equipment receives a DCI indicating/scheduling more than one PDSCH and there is only one valid PDSCH therein, in the HARQ-ACK codebook, a bit value to which the candidate PDSCH reception occasion corresponds=the HARQ-ACK information bits to which the valid PDSCH corresponds. If the terminal equipment receives the DCI indicating/scheduling more than one PDSCH and there are more than one valid PDSCH therein, in the HARQ-ACK codebook, a bit value to which the candidate PDSCH reception occasion corresponds=a binary AND of the bits of the HARQ-ACK information to which the more than one valid PDSCH correspond.

Following description shall be given with reference to example 1 of a pseudocode.

```
A UE determines Õ₀^{ACK}, Õ₁^{ACK},..., Õ_{O}_{_{ACK}}₋₁^{ACK} HARQ-ACK information bits, for a total number
of O_{ACK} HARQ-ACK information bits, of a HARQ-ACK codebook for transmission in a
PUCCH according to the following pseudo-code. In the following pseudo-code, if the UE
does not receive a transport block or a CBG, due to the UE not detecting a corresponding
DCI format, the UE generates a NACK value for the transport block or the CBG. The
cardinality of the set M_{A,c} defines a total number M_{c} of occasions for PDSCH reception or
SPS PDSCH release or TCI state update for serving cell c corresponding to the
HARQ-ACK information bits.
Set c = 0 − serving cell index: lower indexes correspond to lower RRC indexes of
corresponding cells including, when applicable, cells in the set S₀ and the set S₁
Set j = 0- HARQ-ACK information bit index
Set N_{cells}^{DL} to the number of serving cells configured by higher layers for the UE
  while c < N_{cells}^{DL}
    Set m = 0 − index of occasion for candidate PDSCH reception, or SPS PDSCH
      release, or TCI state update
    while m < M_{c}
      if enableTimeDomainHARQ-Bundling is provided for serving cell c and a PDSCH
      associated with occasion m is scheduled by a DCI format indicating a TDRA row
      that includes more than one SLIV entry
        if harq-ACK-SpatialBundlingPUCCH is not provided and the UE is configured
        by maxNrofCodeWordsScheduledByDCI with reception of two transport blocks
        for the active DL BWP of serving cell c
          if two or more PDSCH receptions scheduled by the DCI do not overlap with
            an uplink symbol indicated by tdd-UL-DL-ConfigurationCommon or
            tdd-UL-DL-ConfigurationDedicated, scheduled by the DCI format on
            serving cell c
            õⱼ^{ACK} = binary AND operation of the HARQ-ACK information bits
            corresponding to first transport blocks in the PDSCH receptions;
            j = j + 1;
            õⱼ^{ACK} = binary AND operation of the HARQ-ACK information bits
            corresponding to second transport blocks in the PDSCH receptions;
          else
          õⱼ^{ACK} = HARQ-ACK information bit corresponding to a first transport block of
            the only one valid PDSCH, scheduled by the DCI format on serving cell c
            j = j + 1;
          õⱼ^{ACK} = HARQ-ACK information bit corresponding to a second transport
        block the only one valid PDSCH, scheduled by the DCI format on serving
        cell c;
      end if
    j = j + 1;
  elseif harq-ACK-SpatialBundlingPUCCH is provided and the UE is configured
  by maxNrofCodeWordsScheduledByDCI with reception of two transport blocks
  for the active DL BWP of serving cell c
    if two or more PDSCHs scheduled by the DCI do not overlap with an uplink
      symbol indicated by tdd-UL-DL-ConfigurationCommon or
      tdd-UL-DL-ConfigurationDedicated, scheduled by the DCI format on
      serving cell c;
      õⱼ^{ACK} = binary AND operation of the HARQ-ACK information bits
      corresponding to all transport blocks in the PDSCHs-
        if the UE receives one transport block, the UE assumes ACK for the
        second transport block;
    else
    õⱼ^{ACK} = binary AND operation of the HARQ-ACK information bits
    corresponding to first and second transport blocks of the only one valid
    PDSCH, scheduled by the DCI format on serving cell c
      if the UE receives one transport block, the UE assumes ACK for the second
      transport block;
    end if
    j = j + 1;
else
  if two or more PDSCHs scheduled by the DCI do not overlap with an uplink
  symbol indicated by tdd-UL-DL-ConfigurationCommon or
  tdd-UL-DL-ConfigurationDedicated, scheduled by the DCI format on serving
  cell c;
      õⱼ^{ACK} = binary AND operation of the HARQ-ACK information bits
      corresponding to all transport blocks in the PDSCHs
  else
      õⱼ^{ACK} = HARQ-ACK information bit corresponding to (the transport
      block of) the only one valid PDSCH, scheduled by the DCI format on
      serving cell c;
    end if
    j = j + 1;
  end if
else
  if harq-ACK-SpatialBundlingPUCCH is not provided,
  PDSCH-CodeBlockGroupTransmission is not provided, and the UE is configured
  by maxNrofCodeWordsScheduledByDCI with reception of two transport blocks
  for the active DL BWP of serving cell c,
    õⱼ^{ACK} = HARQ-ACK information bit corresponding to a first transport block of
      this cell;
    j = j + 1;
    õⱼ^{ACK} = HARQ-ACK information bit corresponding to a second transport
      block of this cell;
    j = j + 1;
  elseif harq-ACK-SpatialBundlingPUCCH is provided, and the UE is configured
  by maxNrofCodeWordsScheduledByDCI with reception of two transport blocks
  for the active DL BWP of serving cell c,
    õⱼ^{ACK} = binary AND operation of the HARQ-ACK information bits
    corresponding to first and second transport blocks of this cell
      if the UE receives one transport block, the UE assumes ACK for the second
      transport block;
    j = j + 1;
  elseif PDSCH-CodeBlockGroupTransmission is provided, and N_{HARQ-ACK,c}^{CBG/TB,max}
  CBGs are indicated by maxCodeBlockGroupsPerTransportBlock for serving cell c,
    Set n_{CBG} = 0- CBG index
    while n_{CBG} < N_{HARQ-ACK,c}^{CBG/TB,max}
      õⱼ₊ₙ_{_{CBG}}^{ACK} = HARQ-ACK information bit corresponding to CBG n_{CBG} of
      the first transport block;
      if the UE is configured by maxNrofCodeWordsScheduledByDCI with
      reception of two transport blocks for the active DL BWP of serving cell c
        ${\tilde{o}}_{j + {n}_{CBG} + {N}_{HARQ - ACK , c}^{CBG / TB , max}}^{ACK} = HARQ - ACK information bit corresponding to$
        CBG n_{CBG} of the second transport block;
      end if
      n_{CBG} = n_{CBG} + 1;
    end while
    j = j + N_{TB,c}^{DL} · N_{HARQ-ACK,c}^{CBG/TB,max}, where N_{TB,c}^{DL} is the value of
    maxNrofCodeWordsScheduledByDCI for the active DL BWP of serving cell c;
  else
    õⱼ^{ACK} = HARQ-ACK information bit of serving cell c;
    j = j + 1;
      end if
    end if
    m = m + 1;
  end while
  c = c + 1;
end while
```

That is, in the case where time domain bundling is configured, whether harq-ACK-SpatialBundlingPUCCH and PDSCH-CodeBlockGroupTransmission, etc. are configured is sequentially determined. On the premise of different configurations, a candidate PDSCH reception occasion is associated with more than one PDSCH and whether there are more than one valid PDSCH or there is one valid PDSCH is respectively determined. In the HARQ-ACK codebook, when there are more than one valid PDSCH, the bit value to which the candidate PDSCH reception occasion corresponds=a binary AND of the bits of the HARQ-ACK information to which the more than one valid PDSCH correspond; otherwise, when there is one valid PDSCH, the bit value to which the candidate PDSCH reception occasion corresponds=the HARQ-ACK information bits to which the valid PDSCH corresponds.

Following description shall be given with reference to example 2 of the pseudocode.

```
A UE determines Õ₀^{ACK}, Õ₁^{ACK},..., Õ_{O}_{_{ACK}}₋₁^{ACK} HARQ-ACK information bits, for a total number
of O_{ACK} HARQ-ACK information bits, of a HARQ-ACK codebook for transmission in a
PUCCH according to the following pseudo-code. In the following pseudo-code, if the UE
does not receive a transport block or a CBG, due to the UE not detecting a corresponding
DCI format, the UE generates a NACK value for the transport block or the CBG. The
cardinality of the set M_{A,c} defines a total number M_{c} of occasions for PDSCH reception or
SPS PDSCH release or TCI state update for serving cell c corresponding to the
HARQ-ACK information bits.
Set c = 0 − serving cell index: lower indexes correspond to lower RRC indexes of
corresponding cells including, when applicable, cells in the set S₀ and the set S₁
Set j = 0- HARQ-ACK information bit index
Set N_{cells}^{DL} to the number of serving cells configured by higher layers for the UE
  while c < N_{cells}^{DL}
    Set m = 0 − index of occasion for candidate PDSCH reception, or SPS PDSCH
      release, or TCI state update
    while m < M_{c}
      if enableTimeDomainHARQ-Bundling is provided for serving cell c and a PDSCH
      associated with occasion m is scheduled by a DCI format indicating a TDRA row
      that includes more than one SLIV entry, and two or more PDSCH receptions
      scheduled by the DCI do not overlap with an uplink symbol indicated by
      tdd-UL-DL-ConfigurationCommon or tdd-UL-DL-ConfigurationDedicated,
      scheduled by the DCI format on a serving cell c
        if harq-ACK-SpatialBundlingPUCCH is not provided and the UE is configured
        by maxNrofCodeWordsScheduledByDCI with reception of two transport blocks
        for the active DL BWP of serving cell c
            õⱼ^{ACK} = binary AND operation of the HARQ-ACK information bits
            corresponding to first transport blocks in the PDSCH receptions;
            j = j + 1;
            õⱼ^{ACK} = binary AND operation of the HARQ-ACK information bits
            corresponding to second transport blocks in the PDSCH receptions;
          j = j = 1;
        elseif harq-ACK-SpatialBundlingPUCCH is provided and the UE is configured by
        maxNrofCodeWordsScheduledByDCI with reception of two transport blocks for
        the active DL BWP of serving cell c
      õⱼ^{ACK} = binary AND operation of the HARQ-ACK information bits
      corresponding to all transport blocks in the PDSCHs,
        if the UE receives one transport block, the UE assumes ACK for the
        second transport block;
    j = j + 1;
  else
      õⱼ^{ACK} = binary AND operation of the HARQ-ACK information bits
      corresponding to all transport blocks in the PDSCHs
    j = j + 1;
  end if
else
  if harq-ACK-SpatialBundlingPUCCH is not provided,
  PDSCH-CodeBlockGroupTransmission is not provided, and the UE is configured
  by maxNrofCodeWordsScheduledByDCI with reception of two transport blocks
  for the active DL BWP of serving cell c,
    õⱼ^{ACK} = HARQ-ACK information bit corresponding to a first transport block of
      this cell;
    j = j + 1;
    õⱼ^{ACK} = HARQ-ACK information bit corresponding to a second transport
      block of this cell;
    j = j + 1;
  elseif harq-ACK-SpatialBundlingPUCCH is provided, and the UE is configured
  by maxNrofCodeWordsScheduledByDCI with reception of two transport blocks
  for the active DL BWP of serving cell c,
    õⱼ^{ACK} =binary AND operation of the HARQ-ACK information bits
    corresponding to first and second transport blocks of this cell
      if the UE receives one transport block, the UE assumes ACK for the second
      transport block;
    j = j + 1;
  elseif PDSCH-CodeBlockGroupTransmission is provided, and N_{HARQ-ACK,c}^{CBG/TB,max}
  CBGs are indicated by maxCodeBlockGroupsPerTransportBlock for serving cell c,
    Set n_{CBG} = 0- CBG index
    while n_{CBG} < N_{HARQ-ACK,c}^{CBG/TB,max}
      õⱼ₊ₙ_{_{CBG}}^{ACK} = HARQ-ACK information bit corresponding to CBG n_{CBG} of
      the first transport block;
      if the UE is configured by maxNrofCodeWordsScheduledByDCI with
      reception of two transport blocks for the active DL BWP of serving cell c
      ${\tilde{o}}_{j + {n}_{CBG} + {N}_{HARQ - ACK , c}^{CBG / TB , max}}^{ACK} = HARQ - ACK information bit corresponding to$
        CBG n_{CBG} of the second transport block;
      end if
      n_{CBG} = n_{CBG} + 1;
    end while
    j = j + N_{TB,c}^{DL} · N_{HARQ-ACK,c}^{CBG/TB,max}, where N_{TB,c}^{DL} is the value of
    maxNrofCodeWordsScheduledByDCI for the active DL BWP of serving cell c;
  else
    õⱼ^{ACK} = HARQ-ACK information bit of serving cell c;
    j = j + 1;
      end if
    end if
    m = m + 1;
  end while
  c = c + 1;
end while
```

That is, in the case where time domain bundling is configured, a candidate PDSCH reception occasion is associated with more than one PDSCH and the more than one PDSCH are scheduled by a single DCI, under this premise, whether harq-ACK-SpatialBundlingPUCCH and PDSCH-CodeBlockGroupTransmission, etc. are configured is sequentially determine. In the HARQ-ACK codebook, the bit value to which the candidate PDSCH reception occasion corresponds=a binary AND of the bits of the HARQ-ACK information to which the more than one valid PDSCH correspond; otherwise, when only one valid PDSCH is associated, the bit value to which the candidate PDSCH reception occasion corresponds=the HARQ-ACK information bits to which the valid PDSCH corresponds.

It can be seen from the above embodiments that associating multiple PDSCHs for a candidate PDSCH reception occasion and scheduling the multiple PDSCHs by different DCI or in different manners are not supported, that is, associating multiple PDSCHs for a candidate PDSCH reception occasion and scheduling the multiple PDSCHs by the same DCI are only supported. Hence, the terminal equipment may be prevented from being unable to receive and/or feed back corresponding HARQ-ACK information in the case where multiple PDSCHs are associated for a candidate PDSCH reception occasion and the multiple PDSCHs are scheduled by different DCI or in different manners, thereby avoiding unnecessary retransmission and resource waste; however, this disclosure is not limited thereto.

In some embodiments, in a case of associating multiple PDSCHs for a candidate PDSCH reception occasion, scheduling the multiple PDSCHs by different DCI or in different manners is supported and performing corresponding HARQ-ACK information feedback, which shall be described below in detail.

For example, more than one PDSCH or more than one valid PDSCH with which the same candidate PDSCH reception occasion is associated are scheduled by different DCI, or a part thereof are scheduled by DCI, and other part are SPS PDSCHs (configured by the SPS and activated by the DCI). The bits of the HARQ-ACK information to which the candidate PDSCH reception occasion corresponds are equal to a binary AND of the bits of the HARQ-ACK information to which the associated more than one PDSCH or the associated more than one valid PDSCH correspond.

For example, when the more than one PDSCH associated with the same candidate PDSCH reception occasion include one or more than one SPS PDSCHs, the PDSCHs associated with the candidate PDSCH reception occasion do not include the PDSCHs scheduled by the DCI. That is, if there are one or more than one SPS PDSCH associated with a candidate PDSCH reception occasion, the DCI is not used to further schedule the PDSCHs associated with the candidate PDSCH reception occasion, hence, the more than one PDSCH associated with the candidate PDSCH reception occasion are all SPS PDSCHs. When a candidate PDSCH reception occasion is associated with one SPS PDSCH, the bits of the HARQ-ACK information to which the candidate PDSCH reception occasion corresponds are equal to the bits of the HARQ-ACK information to which the one SPS PDSCH corresponds. When a candidate PDSCH reception occasion is associated with more than one SPS PDSCH, the bits of the HARQ-ACK information to which the candidate PDSCH reception occasion corresponds are equal to a binary AND of the bits of the HARQ-ACK information to which the more than one SPS PDSCH corresponds. The more than one SPS PDSCH corresponds to identical or different SPS configurations, and/or are activated by different DCI. With this example, occurrence of the scenario in FIG. 5C may be avoided.

For example, when the more than one PDSCH with which the same candidate PDSCH reception occasion is associated include one or more than one SPS PDSCH, the PDSCHs with which the candidate PDSCH reception occasion is associated may also include PDSCHs scheduled by the DCI, that is, if there are one or more than one SPS PDSCH associated with a candidate PDSCH reception occasion, the terminal equipment does not receive the SPS PDSCHs upon receiving the DCI for scheduling (one or more) PDSCHs associated with the candidate PDSCH reception occasion (that is, the terminal equipment cancels reception of the SPS PDSCHs). That is, although the more than one PDSCH with which the candidate PDSCH reception occasion is associated includes a SPS PDSCH and a PDSCH scheduled by the DCI, there is no need to feed back HARQ feedback information of the SPS PDSCHs, and the bits of the HARQ-ACK information to which the candidate PDSCH reception occasion corresponds are equal to the bits of the HARQ-ACK information to which the PDSCH scheduled by the DCI corresponds or a binary AND of the bits of the HARQ-ACK information to which the PDSCHs scheduled by the DCI correspond. For example, when the DCI schedules one PDSCH, the bits of the HARQ-ACK information to which the candidate PDSCH reception occasion corresponds are equal to the bits of the HARQ-ACK information to which the PDSCH scheduled by the DCI corresponds, and when the DCI schedules more than one PDSCH, the bits of the HARQ-ACK information to which the candidate PDSCH reception occasion corresponds are equal to a binary AND of the bits of the HARQ-ACK information to which the more than one PDSCH scheduled by the DCI correspond.

The SPS PDSCH is located before or after or in the PDSCH scheduled by the DCI in the time domain. An HARQ process ID to which the SPS PDSCH corresponds is different from an HARQ process ID of the PDSCH scheduled by the DCI, or is identical to an HARQ process ID of a PDSCH in the more than one PDSCH scheduled by the DCI.

In the above example, the method may further include: the terminal equipment receives one or more DCIs scheduling a PDSCH and/or one or more DCIs activating SPS. The above examples may be implemented separately or in a combined manner, and the embodiments of this disclosure is not limited thereto.

In some embodiments, the method may further include: the terminal equipment receives DCI deactivating SPS, wherein the terminal equipment need further to determines the HARQ-ACK information for the DCI, wherein bits in the codebook used to feed back the HARQ-ACK information of the DCI are bits of HARQ-ACK information corresponding to a candidate PDSCH reception occasion associated with SPS PDSCH corresponding to SPS deactivated by the DCI, or, bits in the codebook used to feed back the HARQ-ACK information of the DCI are bits of HARQ-ACK information corresponding to a candidate PDSCH reception occasion associated with SPS PDSCH corresponding to a SPS with a smallest index in multiple deactivated SPSs.

For example, if the terminal equipment needs further to report HARQ-ACK information of other DCI and/or PDSCH, receives DCI deactivating SPS, wherein the terminal equipment need further to determines the HARQ-ACK information for the DCI, wherein bits (positions) in the codebook used to feed back the HARQ-ACK information of the DCI=bits (positions) of HARQ-ACK information corresponding to a candidate PDSCH reception occasion associated with SPS PDSCH corresponding to SPS deactivated by the DCI. When a DCI used to deactivate multiple SPSs, bits in the codebook used to feed back the HARQ-ACK information of the DCI=bits of HARQ-ACK information corresponding to a candidate PDSCH reception occasion associated with SPS PDSCH corresponding to a SPS with a smallest index in multiple deactivated SPSs.

In some embodiments, the method may further include (not shown): the terminal equipment receives, enable time domain bundling configuration information transmitted by the network device. The network device carries the enable time domain bundling configuration information (enableTimeDomainHARQ Bundling) via RRC signaling, and when the enable time domain bundling configuration information is received, it indicates that the terminal equipment is configured with time domain bundling, and the terminal equipment generates the codebook by using the above method only when it is configured with time domain bundling.

In some embodiments, reference may be made to the embodiments of the first aspect for a method for transmitting the codebook, which shall not be described herein any further.

It can be seen from the above embodiments that a case of associating multiple PDSCHs for a candidate PDSCH reception occasion, scheduling the multiple PDSCHs by different DCI or in different manners is supported and corresponding HARQ-ACK information feedback is performed. Hence, the terminal equipment may be prevented from being unable to receive and/or feed back corresponding HARQ-ACK information in the case where multiple PDSCHs are associated for a candidate PDSCH reception occasion and the multiple PDSCHs are scheduled by different DCI or in different manners, thereby avoiding unnecessary retransmission and resource waste.

### EMBODIMENTS OF SEVENTH ASPECT

In the embodiments of the sixth aspect, in the case where time domain bundling is configured, configuring and/or activating SPS is still supported, and a case of associating multiple PDSCHs for a candidate PDSCH reception occasion and scheduling the multiple PDSCHs in different manners may be supported. On the other hand, in the embodiments of the seventh aspect, in a case where time domain bundling is configured, configuring and/or activating SPS is not supported.

The embodiments of this disclosure provide an information configuration method, which shall be described from a network device side.

FIG. 9 is a schematic diagram of the information configuration method of the embodiments of this disclosure. As shown in FIG. 9, the method includes:
901: the network device transmits enable time domain bundling configuration information to a terminal equipment; and
902: the network device does not transmit SPS configuration information to the terminal equipment and/or does not transmit DCI for activating SPS to the terminal equipment.

In some embodiments, the DCI for activating SPS needs to satisfy the following conditions that:
1) CRC of the DCI is scrambled by a CS-RNTI;
2) a value of a new data indication field in the DCI is set to be 0; and
3) if the DCI includes an HARQ feedback timing PDSCH-to-HARQ_feedback timing indicator field, what is provided by the HARQ feedback occasion PDSCH-to-HARQ feedback timing indicator field is not a value that is not applicable in dl-DataToUL-ACK-r16. (The HARQ feedback timing field may possibly not exist, and when it does not exist or when dl-DataToUL-ACK-r16 does not include the value that is not applicable, condition 3 needs not to be taken into account)

When the terminal equipment is provided with a single SPS configuration, the following conditions need to be satisfied when the DCI is used for SPS activation: values of all bits of an HARQ process number field are 0s (i.e. the field is set to be all ‘0’s), and values of all bits in a redundancy version field (or when a format of the DCI is DCI format 1_1, all bits in the redundancy version field for enabled TBs) are 0s (i.e. the field is set to be all ‘0’s). When the terminal equipment is provided with multiple SPS configurations, the following conditions need to be satisfied when the DCI is used for SPS activation: values of all bits in a redundancy version field (or when a format of the DCI is DCI format 1_1, all bits in the redundancy version field for enabled TBs) are 0s (i.e. the field is set to be all ‘0’s).

In some embodiments, the SPS configuration information SPS-Config includes an SPS periodicity periodicity and a PDSCH repetition number pdsch-AggregationFactor, an HARQ process number nrofHARQ-Processes, and an offset harq-ProcID-Offset between HARQ process identifiers. Furthermore, it may include other SPS configurations, and reference may be made to the related art for details, which shall not be repeated herein any further.

In some embodiments, in 901, the network device carries an enable time domain bundling configuration information (enableTimeDomainHARQ Bundling) via RRC signaling, and when the enable time domain bundling configuration information is received, it indicates that the terminal equipment is configured with time domain bundling. In the case where the terminal equipment is configured with time domain bundling, the network device is unable to configure and/or activate SPS. Therefore, in 902, the network device does not transmit the SPS configuration information to the terminal equipment and/or does not transmit the DCI for activating SPS to the terminal equipment.

It can be seen from the above embodiments that in the case where time domain bundling is configured, configuring and/or activating SPS is not supported, and a case of associating multiple PDSCHs for a candidate PDSCH reception occasion and scheduling the multiple PDSCHs in different manners is not supported. Hence, the terminal equipment may be prevented from being unable to receive and/or feed back corresponding HARQ-ACK information in the case where multiple PDSCHs are associated for a candidate PDSCH reception occasion and the multiple PDSCHs are scheduled by different DCI or in different manners, thereby avoiding unnecessary retransmission and resource waste.

### EMBODIMENTS OF EIGHTH ASPECT

The embodiments of this disclosure provide an information configuration method, which shall be described from a terminal equipment side, with parts repeated with those in the embodiments of the seventh aspect being not going to be described herein any further.

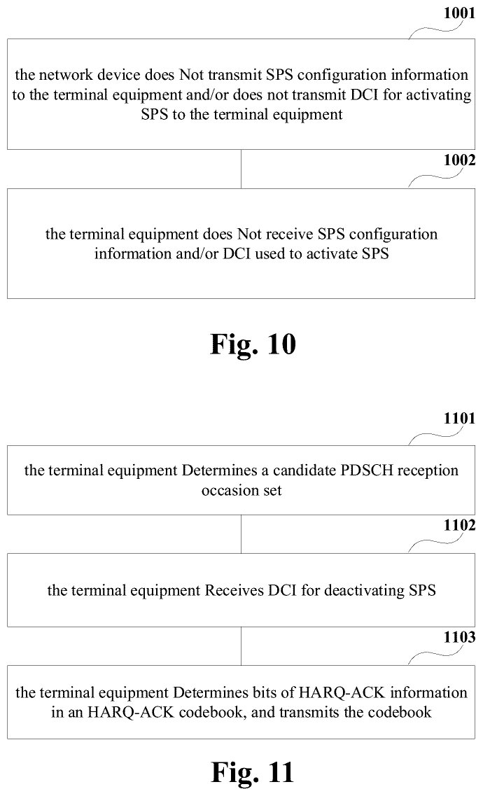

FIG. 10 is a schematic diagram of the information configuration method of the embodiments of this disclosure. As shown in FIG. 10, the method includes:
1001: the terminal equipment receives enable time domain bundling configuration information; and
1002: the terminal equipment does not receive SPS configuration information and/or DCI used to activate SPS.

In some embodiments, implementations of 1001-1002 correspond to those of 901-902 in the embodiments of the seventh aspect, and repeated parts shall not be described herein any further.

In some embodiments, in 1001, the network device carries the enable time domain bundling configuration information (enableTimeDomainHARQ Bundling) via RRC signaling, and when the enable time domain bundling configuration information is received, it indicates that the terminal equipment is configured with time domain bundling. In the case where the terminal equipment is configured with time domain bundling, the network device is unable to configure and/or activate SPS, and the terminal equipment does not receive (is not expected to receive) the SPS configuration information and/or the DCI for activating SPS is not transmitted to the terminal equipment. Reference may be made to the embodiments of the seventh aspect for the SPS configuration information and/or the DCI for activating SPS, which shall not be repeated herein any further.

In some embodiments, in the case where the network device configures time domain bundling, the method may further include: the terminal equipment determines a candidate PDSCH reception occasion set and generates a corresponding HARQ feedback codebook, wherein an existing method for determining a candidate PDSCH reception occasion set in Rel-17 may be reused, or the method for determining the candidate PDSCH reception occasion set in the embodiments of the first aspect may be used, and a specific method is as described above, which shall not be repeated herein any further. In addition, an existing method in Rel-17 may be reused for generating the corresponding HARQ feedback codebook, or, a part of method in the embodiments of the sixth aspect may be used, which shall not be repeated herein any further.

It can be seen from the above embodiments that in the case where time domain bundling is configured, configuring and/or activating SPS is not supported, and a case of associating multiple PDSCHs for a candidate PDSCH reception occasion and scheduling the multiple PDSCHs in different manners is not supported. Hence, the terminal equipment may be prevented from being unable to receive and/or feed back corresponding HARQ-ACK information in the case where multiple PDSCHs are associated for a candidate PDSCH reception occasion and the multiple PDSCHs are scheduled by different DCI or in different manners, thereby avoiding unnecessary retransmission and resource waste.

### EMBODIMENTS OF NINTH ASPECT

The embodiments of this disclosure provide an information feedback method, which shall be described from a terminal equipment side.

FIG. 11 is a schematic diagram of the information feedback method of the embodiments of this disclosure. As shown in FIG. 11, the method includes:
1101: the terminal equipment determines a candidate PDSCH reception occasion set;
1102: the terminal equipment receives DCI for deactivating SPS; and
1103: the terminal equipment determines bits of HARQ-ACK information in an HARQ-ACK codebook, and transmits the codebook, all bits of the codebook being HARQ-ACK information of the DCI, or,
bits in the codebook used to feed back the HARQ-ACK information of the DCI are bits of HARQ-ACK information corresponding to a candidate PDSCH reception occasion associated with SPS PDSCH corresponding to SPS deactivated by the DCI, or,
bits in the codebook used to feed back the HARQ-ACK information of the DCI are bits of HARQ-ACK information corresponding to a candidate PDSCH reception occasion associated with a SPS PDSCH corresponding to a SPS with a smallest index in multiple deactivated SPSs.

In some embodiments, reference may be made to the embodiments of the sixth aspect for implementation of 1101, and repeated parts shall not be described herein any further.

For example, if the terminal equipment needs only to report the HARQ-ACK information of the DCI used to deactivate SPS (that is, the terminal equipment only receives the DCI), all bits included in the codebook are respectively equal to the HARQ-ACK information of the DCI.

For example, if the terminal equipment further needs to report HARQ-ACK information of other DCI and/or a PDSCH, the bits (positions) in the codebook used to feed back the HARQ-ACK information of the DCI are equal to bits (positions) of HARQ-ACK information corresponding to the candidate PDSCH reception occasion associated with the SPS PDSCH to which deactivated SPS corresponds. When the DCI is used to deactivate multiple SPSs, the bits in the codebook used to feed back the HARQ-ACK information of the DCI are equal to the bits of HARQ-ACK information corresponding to the candidate PDSCH reception occasion associated with the SPS PDSCH corresponding to the SPS with a smallest index in multiple deactivated SPSs.

In some embodiments, the apparatus may further include: the terminal equipment receives, enable time domain bundling configuration information transmitted by the network device. The network device carries the enable time domain bundling configuration information (enableTimeDomainHARQ Bundling) via RRC signaling, and when the enable time domain bundling configuration information is received, it indicates that the terminal equipment is configured with time domain bundling. In the case where the terminal equipment is configured with time domain bundling, the above method is used to generate the codebook.

In some embodiments, reference may be made to the embodiments of the first aspect for a method for transmitting the codebook, which shall not be repeated herein any further.

### EMBODIMENTS OF TENTH ASPECT

The embodiments of this disclosure provide an information feedback apparatus. The apparatus may be, for example, a terminal equipment, or one or some components or assemblies configured in the terminal equipment. Contents in the embodiments identical to those in the embodiments of the first aspect shall not be described herein any further.

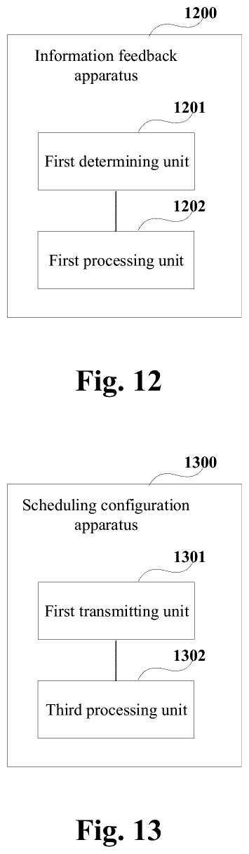

FIG. 12 is a schematic diagram of the information feedback apparatus of the embodiments of this disclosure. As shown in FIG. 12, an information feedback apparatus 1200 includes:
a first determining unit 1201 configured to determine a candidate PDSCH reception occasion set according to whether time domain bundling is configured and/or whether multi-PDSCH scheduling is configured and/or a subcarrier spacing of a downlink BWP and/or whether it is capable of receiving more than one PDSCH in per slot; and
a first processing unit 1202 configured to generate and transmit an HARQ-ACK codebook, the codebook including HARQ-ACK information to which the candidate PDSCH reception occasion set corresponds.

In some embodiments, reference may be made to 201-202 in the embodiments of the first aspect for implementations of the first determining unit 1201 and the first processing unit 1202, and repeated parts shall not be described herein any further.

In some embodiments, when the time domain bundling is configured, the first determining unit adds one PDSCH reception occasion to the candidate PDSCH reception occasion set.

In some embodiments, when the time domain bundling is not configured and the terminal equipment is capable of receiving more than one PDSCH per slot, the first determining unit adds one PDSCH reception occasion or multiple PDSCH reception occasions to the candidate PDSCH reception occasion set according to the number of mutually independent PDSCH time domain resource configurations in a first allocation table.

The embodiments of this disclosure provide a scheduling configuration apparatus. The apparatus may be, for example, a terminal equipment, or one or some components or assemblies configured in the terminal equipment. Contents in the embodiments identical to those in the embodiments of the third aspect shall not be described herein any further.

FIG. 13 is a schematic diagram of the scheduling configuration apparatus of the embodiments of this disclosure. As shown in FIG. 13, a scheduling configuration apparatus 1300 includes:
a first transmitting unit 1301 configured to transmit capability indication information to a network device, the capability indication information being used to indicate that the terminal equipment is capable of receiving more than one PDSCH per slot; and
a third processing unit 1302 configured not to receive enable time domain bundling configuration information configured by the network device and/or not to receive first indication information of a PDSCH time domain resource allocation table configured by the network device.

In some embodiments, reference may be made to 401-402 in the embodiments of the third aspect for implementations of the first transmitting unit 1301 and the third processing unit 1302, and repeated parts shall not be described herein any further.

The embodiments of this disclosure provide a scheduling configuration apparatus. The apparatus may be, for example, a terminal equipment, or one or some components or assemblies configured in the terminal equipment. Contents in the embodiments identical to those in the embodiments of the fifth aspect shall not be described herein any further.

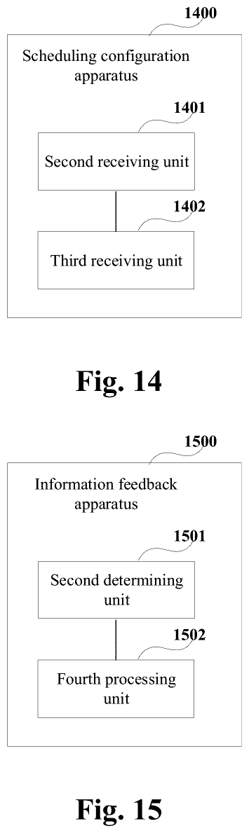

FIG. 14 is a schematic diagram of the scheduling configuration apparatus of the embodiments of this disclosure. As shown in FIG. 14, a scheduling configuration apparatus 1400 includes:
a second receiving unit 1401 configured to receive enable time domain bundling configuration information transmitted by a network device; and
a third receiving unit 1402 configured to receive downlink control information transmitted by the network device, the downlink control information scheduling one PDSCH, or scheduling more than one PDSCH, and more than one PDSCH including more than one valid PDSCH.

In some embodiments, reference may be made to 701-702 in the embodiments of the fifth aspect for implementations of the second receiving unit 1401 and the third receiving unit 1402, and repeated parts shall not be described herein any further.

The embodiments of this disclosure provide an information feedback apparatus. The apparatus may be, for example, a terminal equipment, or one or some components or assemblies configured in the terminal equipment. Contents in the embodiments identical to those in the embodiments of the first aspect shall not be described herein any further.

FIG. 15 is a schematic diagram of the information feedback apparatus of the embodiments of this disclosure. As shown in FIG. 15, an information feedback apparatus 1500 includes:
a second determining unit 1501 configured to determine a candidate PDSCH reception occasion set; and
a fourth processing unit 1502 configured to determine bits of HARQ-ACK information in an HARQ-ACK codebook according to the number of scheduled PDSCHs and/or according to the number of scheduled valid PDSCHs, and transmit the codebook, the codebook including HARQ-ACK information to which the candidate PDSCH reception occasion set corresponds.

In some embodiments, for a candidate PDSCH reception occasion in the candidate PDSCH reception occasion set, the fourth processing unit determines bits of HARQ-ACK information to which the candidate PDSCH reception occasion corresponds according to the number of associated scheduled PDSCHs and/or the number of associated valid PDSCHs with the candidate PDSCH reception occasion.

In some embodiments, the number of associated scheduled PDSCHs and/or the number of associated valid PDSCHs with the candidate PDSCH reception occasion is/are 1, the bits of the HARQ-ACK information to which the candidate PDSCH reception occasion corresponds are equal to the bits of HARQ-ACK information to which the associated scheduled PDSCHs and/or the associated valid PDSCHs correspond(s).

In some embodiments, when the number of associated scheduled PDSCHs and/or the number of associated valid PDSCHs with the candidate PDSCH reception occasion is/are greater than 1, the bits of the HARQ-ACK information to which the candidate PDSCH reception occasion corresponds are equal to a binary AND of bits of HARQ-ACK information to which the associated scheduled PDSCHs and/or the associated valid PDSCHs correspond(s).

In some embodiments, a PDSCH or a valid PDSCH with which the same candidate PDSCH reception occasion is associated is scheduled by the same DCI.

In some embodiments, more than one PDSCH or more than one valid PDSCH with which the same candidate PDSCH reception occasion is associated are scheduled by different DCI, or a part thereof are scheduled by DCI, and other part are SPS PDSCHs.

In some embodiments, for a candidate PDSCH reception occasion in the candidate PDSCH reception occasion set, PDSCH(s) with which the candidate PDSCH reception occasion is associated includes one or more than one SPS PDSCH.

In some embodiments, bits of HARQ-ACK information to which the candidate PDSCH reception occasion corresponds are equal to bits of HARQ-ACK information to which the one SPS PDSCH corresponds, or are equal to a binary AND of bits of HARQ-ACK information to which the more than one SPS PDSCH corresponds.

In some embodiments, the more than one SPS PDSCH correspond to identical or different SPS configurations, and/or are activated by different DCI.

In some embodiments, the PDSCH with which the candidate PDSCH reception occasion is associated does not include a PDSCH scheduled by the DCI.

In some embodiments, the PDSCH with which the candidate PDSCH reception occasion is associated further includes one or more than one PDSCH scheduled by the DCI.

In some embodiments, the bits of the HARQ-ACK information to which the candidate PDSCH reception occasion corresponds are equal to bits of HARQ-ACK information to which the PDSCH scheduled by the DCI corresponds or a binary AND of bits of HARQ-ACK information to which the PDSCHs scheduled by the DCI correspond.

In some embodiments, the apparatus further includes (not shown):
a fifth processing unit configured not to receive a SPS PDSCH.

In some embodiments, the SPS PDSCH are located before or after or in the PDSCH scheduled by the DCI in the time domain.

In some embodiments, an HARQ process ID to which the SPS PDSCH corresponds is different from an HARQ process ID of the PDSCH scheduled by the DCI, or is identical to an HARQ process ID of a PDSCH in the more than one PDSCH scheduled by the DCI.

In some embodiments, the apparatus further includes (not shown):
a fourth receiving unit configured to receive one or more DCIs scheduling a PDSCH and/or one or more DCIs activating SPS.

In some embodiments, the apparatus further includes (not shown):
a fifth receiving unit configured to receive DCI deactivating SPS,
wherein the fourth processing unit determines that bits in the codebook used to feed back the HARQ-ACK information of the DCI are bits of HARQ-ACK information corresponding to a candidate PDSCH reception occasion associated with SPS PDSCH corresponding to SPS deactivated by the DCI, or
that bits in the codebook used to feed back the HARQ-ACK information of the DCI are bits of HARQ-ACK information corresponding to a candidate PDSCH reception occasion associated with SPS PDSCH corresponding to SPS with a smallest index in multiple deactivated SPSs.

In some embodiments, the second determining unit determines a candidate PDSCH reception occasion set according to whether time domain bundling is configured and/or whether multi-PDSCH scheduling is configured and/or a subcarrier spacing of a downlink BWP and/or whether it is capable of receiving more than one PDSCH per slot.

In some embodiments, the apparatus further includes (not shown):
a sixth receiving unit configured to receive enable time domain bundling configuration information transmitted by the network device.

In some embodiments, reference may be made to 801-802 in the embodiments of the sixth aspect for implementations of the second determining unit 1501 and the fourth processing unit 1502, and repeated parts shall not be described herein any further.

The embodiments of this disclosure provide an information configuration apparatus. The apparatus may be, for example, a terminal equipment, or one or some components or assemblies configured in the terminal equipment. Contents in the embodiments identical to those in the embodiments of the eighth aspect shall not be described herein any further.

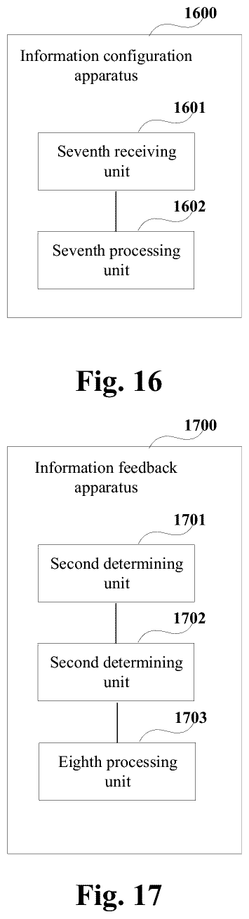

FIG. 16 is a schematic diagram of the information configuration apparatus of the embodiments of this disclosure. As shown in FIG. 16, an information configuration apparatus 1600 includes:
a seventh receiving unit 1601 configured to receive enable time domain bundling configuration information; and
a seventh processing unit 1602 configured not to receive SPS configuration information and/or DCI for activating SPS.

In some embodiments, reference may be made to 1001-1002 in the embodiments of the eighth aspect for implementations of the seventh receiving unit 1601 and the seventh processing unit 1602, and repeated parts shall not be described herein any further.

The embodiments of this disclosure provide an information feedback apparatus. The apparatus may be, for example, a terminal equipment, or one or some components or assemblies configured in the terminal equipment. Contents in the embodiments identical to those in the embodiments of the eighth aspect shall not be described herein any further.

FIG. 17 is a schematic diagram of the information feedback apparatus of the embodiments of this disclosure. As shown in FIG. 17, an information feedback apparatus 1700 includes:
a third determining unit 1701 configured to determine a candidate PDSCH reception occasion set;
a seventh receiving unit 1702 configured to receive DCI for deactivating SPS; and
an eighth processing unit 1703 configured to determine bits of HARQ-ACK information in an HARQ-ACK codebook, and transmit the codebook, all bits of the codebook being HARQ-ACK information of the DCI, or,
bits in the codebook used to feed back the HARQ-ACK information of the DCI are bits of HARQ-ACK information corresponding to a candidate PDSCH reception occasion associated with SPS PDSCH corresponding to SPS deactivated by the DCI, or,
bits in the codebook used to feed back the HARQ-ACK information of the DCI are bits of HARQ-ACK information corresponding to a candidate PDSCH reception occasion associated with SPS PDSCH corresponding to SPS with a smallest index in multiple deactivated SPSs.

In some embodiments, the apparatus further includes (not shown):
an eighth processing unit configured to receive enable time domain bundling configuration information transmitted by the network device.

In some embodiments, reference may be made to 1101-1103 in the embodiments of the ninth aspect for implementations of the third determining unit 1701, the seventh receiving unit 1702 and the eighth processing unit 1703, and repeated parts shall not be described herein any further.

It can be seen from the above embodiments that in a case where time domain bundling is configured, it is specified whether/how to support transmitting/receiving more than one PDSCH per slot, or whether/how to support indicating/scheduling more than one PDSCH with only one valid PDSCH by a physical downlink control channel (PDCCH), or whether/how to support associating more than one PDSCH by a candidate PDSCH reception occasion and scheduling the more than one PDSCH by different DCIs or in different modes, and an HARQ feedback method in the above situations is specified. Hence, the network device and the terminal equipment may have identical understandings of whether the above PDSCH scheduling is allowed, and if the above situations occur when the network device schedules the PDSCHs, the terminal equipment may be able to correctly receive the scheduled PDSCHs and/or feed back corresponding HARQ-ACK information, thereby avoiding unnecessary retransmission and resource waste.

### EMBODIMENTS OF ELEVENTH ASPECT

The embodiments of this disclosure provide a scheduling configuration apparatus. The apparatus may be, for example, a network device, or one or some components or assemblies configured in the network device. Contents in the embodiments identical to those in the embodiments of the second aspect shall not be described herein any further.

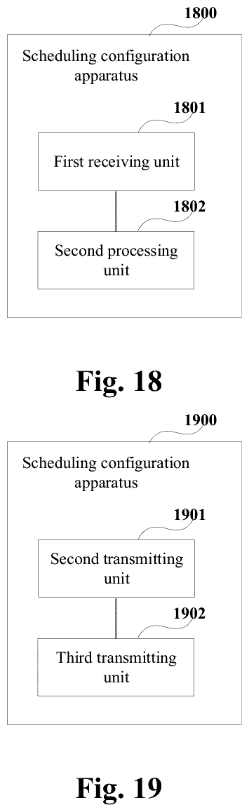

FIG. 18 is a schematic diagram of the scheduling configuration apparatus of the embodiments of this disclosure. As shown in FIG. 18, a scheduling configuration apparatus 1800 includes:
a first receiving unit 1801 configured to receive capability indication information transmitted by a terminal equipment, the capability indication information being used to indicate that the terminal equipment is capable of receiving more than one PDSCH per slot; and
a second processing unit 1802 configured not to transmit enable time domain bundling configuration information to the terminal equipment and/or not to transmit first indication information configuring a PDSCH time domain resource allocation table to the terminal equipment.

In some embodiments, reference may be made to 301-302 in the embodiments of the second aspect for implementations of the first receiving unit 1801 and the second processing unit 1802, and repeated parts shall not be described herein any further.

In some embodiments, the PDSCH time domain resource allocation table supports scheduling more than one PDSCH by a single DCI.

The embodiments of this disclosure provide a scheduling configuration apparatus. The apparatus may be, for example, a network device, or one or some components or assemblies configured in the network device. Contents in the embodiments identical to those in the embodiments of the fourth aspect shall not be described herein any further.

FIG. 19 is a schematic diagram of the scheduling configuration apparatus of the embodiment of this disclosure. As shown in FIG. 19, a scheduling configuration apparatus 1900 includes:
a second transmitting unit 1901 configured to transmit enable time domain bundling configuration information to a terminal equipment; and
a third transmitting unit 1902 configured to transmit downlink control information to the terminal equipment, the downlink control information scheduling one PDSCH, or scheduling more than one PDSCH, and the more than one PDSCH including more than one valid PDSCH.

In some embodiments, reference may be made to 601-602 in the embodiments of the fourth aspect for implementations of the second transmitting unit 1901 and the third transmitting unit 1902, and repeated parts shall not be described herein any further.

The embodiments of this disclosure provide an information configuration apparatus. The apparatus may be, for example, a network device, or one or some components or assemblies configured in the network device. Contents in the embodiments identical to those in the embodiments of the seventh aspect shall not be described herein any further.

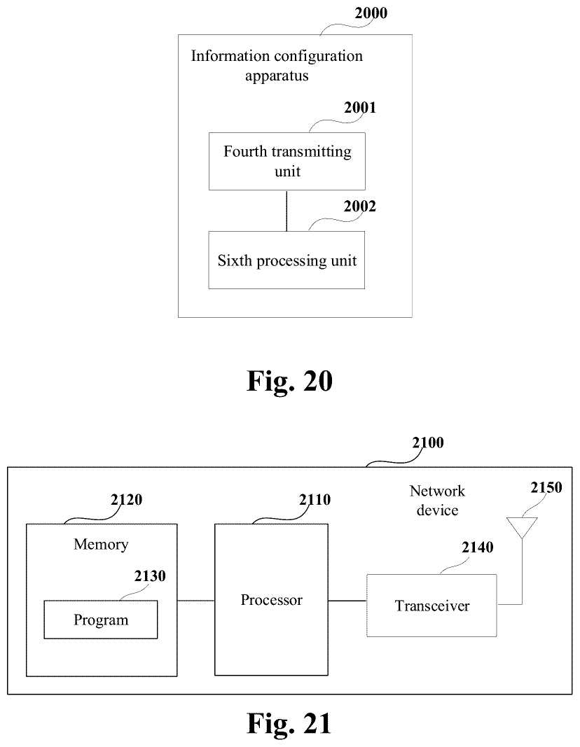

FIG. 20 is a schematic diagram of the information configuration apparatus of the embodiments of this disclosure. As shown in FIG. 20, an information configuration apparatus 2000 includes:
a fourth transmitting unit 2001 configured to transmit enable time domain bundling configuration information to a terminal equipment; and
a sixth processing unit 2002 configured not to transmit SPS configuration information to the terminal equipment and/or not to transmit DCI for activating SPS to the terminal equipment.

In some embodiments, reference may be made to 801-802 in the embodiments of the seventh aspect for implementations of the fourth transmitting unit 2001 and the sixth processing unit 2002, and repeated parts shall not be described herein any further.

It can be seen from the above embodiments that in a case where time domain bundling is configured, it is specified whether/how to support transmitting/receiving more than one PDSCH per slot, or whether/how to support indicating/scheduling more than one PDSCH with only one valid PDSCH by a physical downlink control channel (PDCCH), or whether/how to support associating more than one PDSCH by a candidate PDSCH reception occasion and scheduling the more than one PDSCH by different DCIs or in different modes, and an HARQ feedback method in the above situations is specified.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the apparatuses 1200-2000 may further include other components or modules, and reference may be made to related techniques for particulars of these components or modules.

Furthermore, for the sake of simplicity, connection relationships between the components or modules or signal profiles thereof are only illustrated in FIGS. 12-20. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

### EMBODIMENTS OF TWELFTH ASPECT

The embodiments of this disclosure provide a communication system, and reference may be made to FIG. 1, with contents identical to those in the embodiments of the first to the sixth aspects being not going to be described herein any further.

In some embodiments, the communication system 100 may at least include: a terminal equipment 102 and a network device 101.

In some embodiments, reference may be made to the terminal equipment 1100 for implementation of the terminal equipment 102, and reference may be made to the network device 100 for implementation of the network device, which shall not be described herein any further.

The embodiments of this disclosure further provide a network device, which may be, for example, a base station. However, this disclosure is not limited thereto, and it may also be another network device.

FIG. 21 is a schematic diagram of a structure of the network device of the embodiments of this disclosure. As shown in FIG. 21, a network device 2100 may include a processor 2110 (such as a central processing unit (CPU)) and a memory 2120, the memory 2120 being coupled to the processor 2110. The memory 2120 may store various data, and furthermore, it may store a program 2130 for information processing, and execute the program 2130 under control of the processor 2110.

For example, the processor 2110 may be configured to execute a program to carry out the methods described in the embodiments of second, fourth and seventh aspects.

Furthermore, as shown in FIG. 21, the network device 2100 may include a transceiver 2140, and an antenna 2150, etc. Functions of the above components are similar to those in the related art, and shall not be described herein any further. It should be noted that the network device 2100 does not necessarily include all the parts shown in FIG. 21, and furthermore, the network device 2100 may include parts not shown in FIG. 21, and the related art may be referred to.

The embodiments of this disclosure further provide a terminal equipment; however, this disclosure is not limited thereto, and it may also be another equipment.

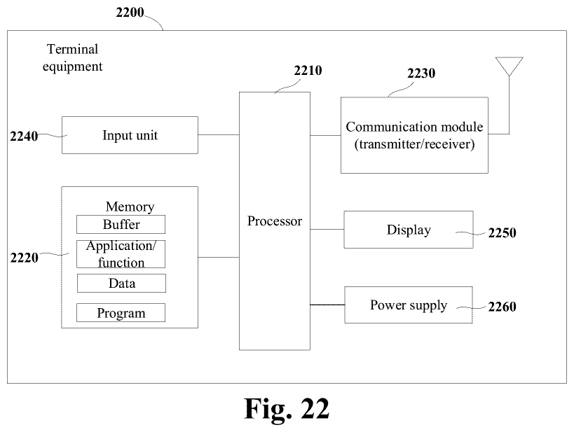

FIG. 22 is a schematic diagram of the terminal equipment of the embodiments of this disclosure. As shown in FIG. 22, a terminal equipment 2200 may include a processor 2210 and a memory 2220, the memory 2220 storing data and a program and being coupled to the processor 2210. It should be noted that this figure is illustrative only, and other types of structures may also be used, so as to supplement or replace this structure and achieve a telecommunications function or other functions.

For example, the processor 2210 may be configured to execute a program to carry out the methods as described in the embodiments of the first, third, fifth, sixth, eighth and ninth aspects.

As shown in FIG. 22, the terminal equipment 2200 may further include a communication module 2230, an input unit 2240, a display 2250, and a power supply 2260, wherein functions of the above components are similar to those in the related art, which shall not be described herein any further. It should be noted that the terminal equipment 2200 does not necessarily include all the parts shown in FIG. 22, and the above components are not necessary. Furthermore, the terminal equipment 2200 may include parts not shown in FIG. 22, and the related art may be referred to.

Embodiments of this disclosure provides a computer readable program, which, when executed in a terminal equipment, causes the terminal equipment to carry out the methods as described in the embodiments of the first, third, fifth, sixth, eighth and ninth aspects.

Embodiments of this disclosure provides a computer storage medium, including a computer readable program, which causes a terminal equipment to carry out the methods as described in the embodiments of the first, third, fifth, sixth, eighth and ninth aspects.

Embodiments of this disclosure provides a computer readable program, which, when executed in a network device, causes the network device to carry out the methods as described in the embodiments of the second, fourth and seventh aspects.

Embodiments of this disclosure provides a computer storage medium, including a computer readable program, which causes a network device to carry out the methods as described in the embodiments of the second, fourth and seventh aspects.

Embodiments of this disclosure provides a computer readable program, which, when executed in a terminal equipment, causes the terminal equipment to carry out the information feedback method as described in the embodiments of the third aspect.

Embodiments of this disclosure provides a computer storage medium, including a computer readable program code, which causes a terminal equipment to carry out the information feedback method as described in the embodiments of the third aspect.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, an EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of this disclosure. Various variants and modifications may be made by those skilled in the art according to the spirits and principle of this disclosure, and such variants and modifications fall within the scope of this disclosure.

As to implementations containing the above embodiments, following supplements are further disclosed.
1. An information feedback method, characterized in that the method includes:
determining a candidate PDSCH reception occasion set by a terminal equipment according to whether time domain bundling is configured and/or whether multi-PDSCH scheduling is configured and/or a subcarrier spacing of a downlink BWP and/or whether it is capable of receiving more than one PDSCH per slot; and
generating and transmitting an HARQ-ACK codebook by the terminal equipment, the codebook including HARQ-ACK information to which the candidate PDSCH reception occasion set corresponds.
2. The method according to supplement 1, wherein the determining a candidate PDSCH reception occasion set by a terminal equipment according to whether time domain bundling is configured includes:
when the time domain bundling is configured, adding one PDSCH reception occasion to the candidate PDSCH reception occasion set.
3. The method according to supplement 1 or 2, wherein,
when the time domain bundling is not configured and the terminal equipment is capable of receiving more than one PDSCH per slot, one PDSCH reception occasion or multiple PDSCH reception occasions is/are added to the candidate PDSCH reception occasion set according to the number of mutually independent PDSCH time domain resource configurations in a first allocation table.
4. A scheduling configuration method, characterized in that the method includes:
receiving, by a network device, capability indication information transmitted by a terminal equipment, the capability indication information being used to indicate that the terminal equipment is capable of receiving more than one PDSCH per slot; and
not transmitting enable time domain bundling configuration information to the terminal equipment and/or not transmitting first indication information configuring a PDSCH time domain resource allocation table to the terminal equipment by the network device.
5. The method according to supplement 4, wherein the PDSCH time domain resource allocation table supports scheduling more than one PDSCH by a single DCI.
6. A scheduling configuration method, characterized in that the method includes:
transmitting capability indication information by a terminal equipment to a network device, the capability indication information being used to indicate that the terminal equipment is capable of receiving more than one PDSCH per slot; and
not receiving, by the terminal equipment, enable time domain bundling configuration information configured by the network device and/or not receiving, by the terminal equipment, first indication information of a PDSCH time domain resource allocation table configured by the network device.
7. A scheduling configuration method, characterized in that the method includes:
transmitting enable time domain bundling configuration information by a network device to a terminal equipment; and
transmitting downlink control information by the network device to the terminal equipment, the downlink control information scheduling one PDSCH, or scheduling more than one PDSCH, and the more than one PDSCH including more than one valid PDSCH.
8. A scheduling configuration method, characterized in that the method includes:
receiving, by a terminal equipment, enable time domain bundling configuration information transmitted by a network device; and
receiving, by the terminal equipment, downlink control information transmitted by the network device, the downlink control information scheduling one PDSCH, or scheduling more than one PDSCH, and more than one PDSCH including more than one valid PDSCH.
9. An information feedback method, characterized in that the method includes:
determining a candidate PDSCH reception occasion set by a terminal equipment; and
determining bits of HARQ-ACK information in an HARQ-ACK codebook according to the number of scheduled PDSCHs and/or according to the number of scheduled valid PDSCHs, and transmitting the codebook, by the terminal equipment, the codebook including HARQ-ACK information to which the candidate PDSCH reception occasion set corresponds.
10. The method according to supplement 9, wherein for a candidate PDSCH reception occasion in the candidate PDSCH reception occasion set the terminal equipment determines bits of HARQ-ACK information to which the candidate PDSCH reception occasion corresponds according to the number of associated scheduled PDSCHs and/or the number of associated valid PDSCHs with the candidate PDSCH reception occasion.
11. The method according to supplement 10, wherein when the number of associated scheduled PDSCHs and/or the number of associated valid PDSCHs with the candidate PDSCH reception occasion is/are 1, the bits of the HARQ-ACK information to which the candidate PDSCH reception occasion corresponds are equal to the bits of HARQ-ACK information to which the associated scheduled PDSCH and/or the associated valid PDSCH corresponds.
12. The method according to supplement 10, wherein when the number of associated scheduled PDSCHs and/or the number of associated valid PDSCHs with the candidate PDSCH reception occasion is/are greater than 1, the bits of the HARQ-ACK information to which the candidate PDSCH reception occasion corresponds are equal to a binary AND of bits of HARQ-ACK information to which the associated scheduled PDSCHs and/or the associated valid PDSCHs corresponds.
13. The method according to any one of supplements 10-12, wherein a PDSCH or a valid PDSCH with which the same candidate PDSCH reception occasion is associated is scheduled by the same DCI.
14. The method according to supplement 10, wherein more than one PDSCH or more than one valid PDSCH with which the same candidate PDSCH reception occasion is associated are scheduled by different DCI, or a part thereof are scheduled by DCI, and other part are SPS PDSCHs.
15. The method according to supplement 9, wherein for a candidate PDSCH reception occasion in the candidate PDSCH reception occasion set, PDSCH(s) with which the candidate PDSCH reception occasion is associated includes one or more than one SPS PDSCH.
16. The method according to supplement 15, wherein bits of HARQ-ACK information to which the candidate PDSCH reception occasion corresponds are equal to bits of HARQ-ACK information to which the one SPS PDSCH corresponds, or are equal to a binary AND of bits of HARQ-ACK information to which the more than one SPS PDSCH correspond.
17. The method according to supplement 15, wherein the more than one SPS PDSCH correspond to identical or different SPS configurations, and/or are activated by different DCI.
18. The method according to any one of supplements 15-17, wherein a PDSCH with which the candidate PDSCH reception occasion is associated does not include a PDSCH scheduled by the DCI.
19. The method according to supplement 15, wherein a PDSCH with which the candidate PDSCH reception occasion is associated further includes one or more than one PDSCH scheduled by the DCI.
20. The method according to supplement 19, wherein the bits of the HARQ-ACK information to which the candidate PDSCH reception occasion corresponds are equal to bits of HARQ-ACK information to which the PDSCH scheduled by the DCI corresponds or a binary AND of bits of HARQ-ACK information to which the PDSCHs scheduled by the DCI correspond.
21. The method according to supplement 19 or 20, wherein the method further includes: not receiving a SPS PDSCH by the terminal equipment.
22. The method according to any one of supplements 19-21, wherein a SPS PDSCH is located before or after or in the PDSCH scheduled by the DCI in the time domain.
23. The method according to any one of supplements 19-22, wherein an HARQ process ID to which the SPS PDSCH corresponds is different from an HARQ process ID of the PDSCH scheduled by the DCI, or is identical to an HARQ process ID of a PDSCH in the more than one PDSCH scheduled by the DCI.
24. The method according to any one of supplement 13-23, wherein the method further includes:
receiving one or more DCIs scheduling a PDSCH and/or one or more DCIs activating SPS by the terminal equipment.
25. The method according to supplement 9, wherein the method further includes:
receiving DCI deactivating SPS by the terminal equipment; and
determining that bits in the codebook used to feed back the HARQ-ACK information of the DCI are bits of HARQ-ACK information corresponding to a candidate PDSCH reception occasion associated with SPS PDSCH corresponding to SPS deactivated by the DCI, or
that bits in the codebook used to feed back the HARQ-ACK information of the DCI are bits of HARQ-ACK information corresponding to a candidate PDSCH reception occasion associated with SPS PDSCH corresponding to SPS with a smallest index in multiple deactivated SPSs.
26. The method according to any one of supplements 9-25, wherein,
the terminal equipment determines the candidate PDSCH reception occasion set according to whether time domain bundling is configured and/or whether multi-PDSCH scheduling is configured and/or a subcarrier spacing of a downlink BWP and/or whether it is capable of receiving more than one PDSCH per slot.
27. The method according to any one of supplements 8-26, wherein the method further includes:
receiving, by the terminal equipment, enable time domain bundling configuration information transmitted by the network device.
28. An information configuration method, characterized in that the method includes:
transmitting enable time domain bundling configuration information by a network device to a terminal equipment; and
not transmitting SPS configuration information by the network device to the terminal equipment and/or not transmitting DCI for activating SPS by the network device to the terminal equipment.
29. An information configuration method, characterized in that the method includes:
receiving enable time domain bundling configuration information by a terminal equipment; and
not receiving SPS configuration information and/or DCI for activating SPS by the terminal equipment.
30. An information feedback method, characterized in that the method includes:
determining a candidate PDSCH reception occasion set by a terminal equipment;
receiving DCI for deactivating SPS by the terminal equipment; and
determining bits of HARQ-ACK information in an HARQ-ACK codebook, and transmitting the codebook, by the terminal equipment, all bits of the codebook being HARQ-ACK information of the DCI, or,
that bits in the codebook used to feed back the HARQ-ACK information of the DCI are bits of HARQ-ACK information corresponding to a candidate PDSCH reception occasion associated with SPS PDSCH corresponding to SPS deactivated by the DCI, or,
that bits in the codebook used to feed back the HARQ-ACK information of the DCI are bits of HARQ-ACK information corresponding to a candidate PDSCH reception occasion associated with SPS PDSCH corresponding to SPS with a smallest index in multiple deactivated SPSs.
31. The method according to supplement 30, wherein the method further includes:
receiving, by the terminal equipment, enable time domain bundling configuration information transmitted by the network device.
32. A network device, including a memory and a processor, the memory storing a computer program, and the processor being configured to execute the computer program to carry out the method as described in any one of supplements 4, 5, 7 and 28.
33. A terminal equipment, including a memory and a processor, the memory storing a computer program, and the processor being configured to execute the computer program to carry out the method as described in any one of supplements 1-3, 6, 8-27 and 29-31.
34. A communication system, including:
the terminal equipment as described in supplement 33, and/or the network device as described in supplement 32.

As to implementations containing the above embodiments, following supplements are further disclosed.
1. An information feedback apparatus, characterized in that the apparatus is applicable to a terminal equipment, and the apparatus includes:
a first determining unit configured to determine a candidate PDSCH reception occasion set according to whether time domain bundling is configured and/or whether multi-PDSCH scheduling is configured and/or a subcarrier spacing of a downlink BWP and/or whether it is capable of receiving more than one PDSCH per slot; and
a first processing unit configured to generate and transmit an HARQ-ACK codebook, the codebook including HARQ-ACK information to which the candidate PDSCH reception occasion set corresponds.
2. The apparatus according to supplement 1, wherein when the time domain bundling is configured, the first determining unit adds one PDSCH reception occasion to the candidate PDSCH reception occasion set.
3. The apparatus according to supplement 1 or 2, wherein when the time domain bundling is not configured and the terminal equipment is capable of receiving more than one PDSCH per slot, the first determining unit adds one PDSCH reception occasion or multiple PDSCH reception occasions to the candidate PDSCH reception occasion set according to the number of mutually independent PDSCH time domain resource configurations in a first allocation table.
4. A scheduling configuration apparatus, characterized in that the apparatus is applicable to a network device, and the apparatus includes:
a first receiving unit configured to receive capability indication information transmitted by a terminal equipment, the capability indication information being used to indicate that the terminal equipment is capable of receiving more than one PDSCH per slot; and
a second processing unit configured not to transmit enable time domain bundling configuration information to the terminal equipment and/or not to transmit first indication information configuring a PDSCH time domain resource allocation table to the terminal equipment.
5. The apparatus according to supplement 4, wherein the PDSCH time domain resource allocation table supports scheduling more than one PDSCH by a single DCI.
6. A scheduling configuration apparatus, characterized in that the apparatus is applicable to a terminal equipment, and the apparatus includes:
a first transmitting unit configured to transmit capability indication information to a network device, the capability indication information being used to indicate that the terminal equipment is capable of receiving more than one PDSCH per slot; and
a third processing unit configured not to receive enable time domain bundling configuration information configured by the network device and/or not to receive first indication information of a PDSCH time domain resource allocation table configured by the network device.
7. A scheduling configuration apparatus, characterized in that the apparatus is applicable to a network device, and the apparatus includes:
a second transmitting unit configured to transmit enable time domain bundling configuration information to a terminal equipment; and
a third transmitting unit configured to transmit downlink control information to the terminal equipment, the downlink control information scheduling one PDSCH, or scheduling more than one PDSCH, and the more than one PDSCH including more than one valid PDSCH.
8. A scheduling configuration apparatus, characterized in that the apparatus is applicable to a terminal equipment, and the apparatus includes:
a second receiving unit configured to receive enable time domain bundling configuration information transmitted by a network device; and
a third receiving unit configured to receive downlink control information transmitted by the network device, the downlink control information scheduling one PDSCH, or scheduling more than one PDSCH, and more than one PDSCH including more than one valid PDSCH.
9. An information feedback apparatus, characterized in that the apparatus is applicable to a terminal equipment, and the apparatus includes:
a second determining unit configured to determine a candidate PDSCH reception occasion set; and
a fourth processing unit configured to determine bits of HARQ-ACK information in an HARQ-ACK codebook according to the number of scheduled PDSCHs and/or according to the number of scheduled valid PDSCHs, and transmit the codebook, the codebook including HARQ-ACK information to which the candidate PDSCH reception occasion set corresponds.
10. The apparatus according to supplement 9, wherein for a candidate PDSCH reception occasion in the candidate PDSCH reception occasion set, the fourth processing unit determines bits of HARQ-ACK information to which the candidate PDSCH reception occasion corresponds according to the number of associated scheduled PDSCHs and/or the number of associated valid PDSCHs with the candidate PDSCH reception occasion.
11. The apparatus according to supplement 10, wherein when the number of associated scheduled PDSCHs and/or the number of associated valid PDSCHs with the candidate PDSCH reception occasion is/are 1, the bits of the HARQ-ACK information to which the candidate PDSCH reception occasion corresponds are equal to the bits of HARQ-ACK information to which the associated scheduled PDSCH and/or the associated valid PDSCH corresponds.
12. The apparatus according to supplement 10, wherein when the number of associated scheduled PDSCHs and/or the number of associated valid PDSCHs with the candidate PDSCH reception occasion is/are greater than 1, the bits of the HARQ-ACK information to which the candidate PDSCH reception occasion corresponds are equal to a binary AND of bits of HARQ-ACK information to which the associated scheduled PDSCHs and/or the associated valid PDSCHs corresponds.
13. The apparatus according to any one of supplements 10-12, wherein a PDSCH or a valid PDSCH with which the same candidate PDSCH reception occasion is associated is scheduled by the same DCI.
14. The apparatus according to supplement 10, wherein more than one PDSCH or more than one valid PDSCH with which the same candidate PDSCH reception occasion is associated are scheduled by different DCI, or a part thereof are scheduled by DCI, and other part are SPS PDSCHs.
15. The apparatus according to supplement 9, wherein for a candidate PDSCH reception occasion in the candidate PDSCH reception occasion set, PDSCH(s) with which the candidate PDSCH reception occasion is associated includes one or more than one SPS PDSCH.
16. The apparatus according to supplement 15, wherein bits of HARQ-ACK information to which the candidate PDSCH reception occasion corresponds are equal to bits of HARQ-ACK information to which the one SPS PDSCH corresponds, or are equal to a binary AND of bits of HARQ-ACK information to which the more than one SPS PDSCH correspond.
17. The apparatus according to supplement 15, wherein the more than one SPS PDSCH correspond to identical or different SPS configurations, and/or are activated by different DCI.
18. The apparatus according to any one of supplements 15-17, wherein a PDSCH with which the candidate PDSCH reception occasion is associated does not include a PDSCH scheduled by the DCI.
19. The apparatus according to supplement 15, wherein a PDSCH with which the candidate PDSCH reception occasion is associated further includes one or more than one PDSCH scheduled by the DCI.
20. The apparatus according to supplement 19, wherein the bits of the HARQ-ACK information to which the candidate PDSCH reception occasion corresponds are equal to bits of HARQ-ACK information to which the PDSCH scheduled by the DCI corresponds or a binary AND of bits of HARQ-ACK information to which the PDSCHs scheduled by the DCI correspond.
21. The apparatus according to supplement 19 or 20, wherein the apparatus further includes:
a fifth processing unit configured not to receive a SPS PDSCH.
22. The apparatus according to any one of supplements 19-21, wherein a SPS PDSCH is located before or after or in the PDSCH scheduled by the DCI in the time domain.
23. The apparatus according to any one of supplements 19-22, wherein an HARQ process ID to which the SPS PDSCH corresponds is different from an HARQ process ID of the PDSCH scheduled by the DCI, or is identical to an HARQ process ID of a PDSCH in the more than one PDSCH scheduled by the DCI.
24. The apparatus according to any one of supplement 13-23, wherein the apparatus further includes:
a fourth receiving unit configured to receive one or more DCIs scheduling a PDSCH and/or one or more DCIs activating SPS.
25. The apparatus according to supplement 9, wherein the apparatus further includes:
a fifth receiving unit configured to receive DCI deactivating SPS,
wherein the fourth processing unit determines that bits in the codebook used to feed back the HARQ-ACK information of the DCI are bits of HARQ-ACK information corresponding to a candidate PDSCH reception occasion associated with SPS PDSCH corresponding to SPS deactivated by the DCI, or
that bits in the codebook used to feed back the HARQ-ACK information of the DCI are bits of HARQ-ACK information corresponding to a candidate PDSCH reception occasion associated with SPS PDSCH corresponding to SPS with a smallest index in multiple deactivated SPSs.
26. The apparatus according to any one of supplements 9-25, wherein, the second determining unit determines a candidate PDSCH reception occasion set according to whether time domain bundling is configured and/or whether multi-PDSCH scheduling is configured and/or a subcarrier spacing of a downlink BWP and/or whether it is capable of receiving more than one PDSCH per slot.
27. The apparatus according to any one of supplements 8-26, wherein the apparatus further includes:
a sixth receiving unit configured to receive enable time domain bundling configuration information transmitted by the network device.
28. An information configuration apparatus, characterized in that the apparatus is applicable to a network device, and the apparatus includes:
a fourth transmitting unit configured to transmit enable time domain bundling configuration information to a terminal equipment; and
a sixth processing unit configured not to transmit SPS configuration information to the terminal equipment and/or not to transmit DCI for activating SPS to the terminal equipment.
29. An information configuration apparatus, characterized in that the apparatus is applicable to a terminal equipment, and the apparatus includes:
a seventh receiving unit configured to receive enable time domain bundling configuration information; and
a seventh processing unit configured not to receive SPS configuration information and/or DCI for activating SPS.
30. An information feedback apparatus, characterized in that the apparatus is applicable to a terminal equipment, and the apparatus includes:
a third determining unit configured to determine a candidate PDSCH reception occasion set;
a seventh receiving unit configured to receive DCI for deactivating SPS; and
an eighth processing unit configured to determine bits of HARQ-ACK information in an HARQ-ACK codebook, and transmit the codebook, all bits of the codebook being HARQ-ACK information of the DCI, or,
bits in the codebook used to feed back the HARQ-ACK information of the DCI are bits of HARQ-ACK information corresponding to a candidate PDSCH reception occasion associated with SPS PDSCH corresponding to SPS deactivated by the DCI, or,
bits in the codebook used to feed back the HARQ-ACK information of the DCI are bits of HARQ-ACK information corresponding to a candidate PDSCH reception occasion associated with SPS PDSCH corresponding to SPS with a smallest index in multiple deactivated SPSs.
31. The apparatus according to supplement 30, wherein the apparatus further includes:
an eighth processing unit configured to receive enable time domain bundling configuration information transmitted by the network device.

1. An information feedback apparatus, applicable to a terminal equipment, the information feedback apparatus comprising:
processor circuitry configured to:
determine a candidate PDSCH reception occasion set, and
determine bits of HARQ-ACK information in an HARQ-ACK codebook according to the number of scheduled PDSCHs and/or according to the number of scheduled valid PDSCHs; and
a transmitter configured to transmit the codebook, the codebook including HARQ-ACK information to which the candidate PDSCH reception occasion set corresponds.

2. The information feedback apparatus according to claim 1, wherein for a candidate PDSCH reception occasion in the candidate PDSCH reception occasion set, the fourth processing unit determines bits of HARQ-ACK information to which the candidate PDSCH reception occasion corresponds according to the number of PDSCHs scheduled by a single DCI associated with the candidate PDSCH reception occasion and/or the number of valid PDSCHs scheduled by a single DCI associated with the candidate PDSCH reception occasion.

3. The information feedback apparatus according to claim 1, wherein when the number of PDSCHs scheduled by a single DCI associated with the candidate PDSCH reception occasion is greater than 1 and the number of valid PDSCHs scheduled by the single DCI associated with the candidate PDSCH reception occasion is 1, the bits of the HARQ-ACK information to which the candidate PDSCH reception occasion corresponds are equal to the bits of HARQ-ACK information to which the associated valid PDSCH corresponds.

4. The information feedback apparatus according to claim 2, wherein when the number of PDSCHs scheduled by the single DCI associated with the candidate PDSCH reception occasion and the number of valid PDSCHs scheduled by the single DCI associated with the candidate PDSCH reception occasion are greater than 1, the bits of the HARQ-ACK information to which the candidate PDSCH reception occasion corresponds are equal to a binary AND of bits of HARQ-ACK information to which the associated valid PDSCHs correspond.

5. The information feedback apparatus according to claim 2, wherein a PDSCH or a valid PDSCH with which the same candidate PDSCH reception occasion is associated is scheduled by the same DCI.

6. The information feedback apparatus according to claim 2, wherein more than one PDSCH or more than one valid PDSCH with which the same candidate PDSCH reception occasion is associated are scheduled by different DCI, or a part thereof are scheduled by DCI, and the other part are SPS PDSCHs.

7. The information feedback apparatus according to claim 1, wherein for a candidate PDSCH reception occasion in the candidate PDSCH reception occasion set, PDSCH(s) with which the candidate PDSCH reception occasion is associated comprises one or more than one SPS PDSCH.

8. The information feedback apparatus according to claim 7, wherein bits of HARQ-ACK information to which the candidate PDSCH reception occasion corresponds are equal to bits of HARQ-ACK information to which the one SPS PDSCH corresponds, or are equal to a binary AND of bits of HARQ-ACK information to which the more than one SPS PDSCH correspond.

9. The information feedback apparatus according to claim 7, wherein the more than one SPS PDSCH correspond to identical or different SPS configurations, and/or are activated by different DCI.

10. The information feedback apparatus according to claim 7, wherein a PDSCH with which the candidate PDSCH reception occasion is associated does not include a PDSCH scheduled by the DCI.

11. The information feedback apparatus according to claim 7, wherein a PDSCH with which the candidate PDSCH reception occasion is associated further comprises one or more than one PDSCH scheduled by the DCI.

12. The information feedback apparatus according to claim 11, wherein the bits of the HARQ-ACK information to which the candidate PDSCH reception occasion corresponds are equal to bits of HARQ-ACK information to which the PDSCH scheduled by the DCI corresponds or a binary AND of bits of HARQ-ACK information to which the PDSCHs scheduled by the DCI correspond.

13. The information feedback apparatus according to claim 11, wherein the processor circuitry is further configured to control to not receive a SPS PDSCH.

14. The information feedback apparatus according to claim 11, wherein a SPS PDSCH is located before or after or in the PDSCHs scheduled by the DCI in the time domain.

15. The information feedback apparatus according to claim 11, wherein an HARQ process ID to which the SPS PDSCH corresponds is different from an HARQ process ID of the PDSCH scheduled by the DCI, or is identical to an HARQ process ID of a PDSCH in the more than one PDSCH scheduled by the DCI.

16. The information feedback apparatus according to claim 5, further comprising:
a receiver configured to receive one or more DCIs scheduling a PDSCH and/or one or more DCIs activating SPS.

17. The information feedback apparatus according to claim 1, further comprising:
a receiver configured to receive DCI deactivating SPS;
wherein the processor circuitry determines that bits in the codebook used to feed back the HARQ-ACK information of the DCI are bits of HARQ-ACK information corresponding to a candidate PDSCH reception occasion associated with SPS PDSCH corresponding to SPS deactivated by the DCI, or
that bits in the codebook used to feed back the HARQ-ACK information of the DCI are bits of HARQ-ACK information corresponding to a candidate PDSCH reception occasion associated with SPS PDSCH corresponding to SPS with a smallest index in multiple deactivated SPSs.

18. The information feedback apparatus according to claim 1, wherein,
the processor circuitry determines the candidate PDSCH reception occasion set according to whether time domain bundling is configured and/or whether multi-PDSCH scheduling is configured and/or a subcarrier spacing of a downlink BWP and/or whether it is capable of receiving more than one PDSCH per slot.

19. A network device comprising:
a transmitter configured to transmit PDSCHs; and
a receiver configured to receive an HARQ-ACK codebook including HARQ-ACK information to which a candidate PDSCH reception occasion set corresponds, bits of the HARQ-ACK information in the HARQ-ACK codebook is according to the number of scheduled PDSCHs and/or according to the number of scheduled valid PDSCHs.

20. An information feedback apparatus, applicable to a terminal equipment, the information feedback apparatus comprising:
processor circuitry configured to:
determine a candidate PDSCH reception occasion set according to whether time domain bundling is configured and/or whether multi-PDSCH scheduling is configured and/or a subcarrier spacing of a downlink BWP and/or whether it is capable of receiving more than one PDSCH per slot, and
a transmitter configured to transmit an HARQ-ACK codebook, the codebook including HARQ-ACK information to which the candidate PDSCH reception occasion set corresponds.
